(19) United States
(12) Patent Application Publication
(10) Pub. No.: US 2025/0236497 A1
(43) Pub. Date: Jul. 24, 2025

(54) PORTABLE CAR LIFTING MECHANISM AND APPARATUS, AND SYSTEM

(71) Applicant: Guangzhou Haoxiangfa Information Technology Co., Ltd., Guangdong (CN)

(72) Inventor: Yongfeng WU, Guangdong (CN)

(73) Assignee: Guangzhou Haoxiangfa Information Technology Co., Ltd., Guangdong (CN)

(21) Appl. No.: 19/175,562

(22) Filed: Apr. 10, 2025

Related U.S. Application Data
(63) Continuation of application No. PCT/CN2023/123584, filed on Oct. 9, 2023.

(30) Foreign Application Priority Data
Oct. 11, 2022 (CN) 202211241274.0
Feb. 17, 2025 (CN) 202520255786.5
Feb. 17, 2025 (CN) 202520255912.7

(51) Int. Cl. B66F 3/08

(52) U.S. Cl. CPC B66F 3/08

(57) ABSTRACT

The present application discloses a portable car lifting mechanism and apparatus, and a system. The portable car lifting mechanism includes a base; a moving unit fixedly provided relative to the base; and a supporting part capable of moving relative to the base along a vertical direction Y under the driving of the moving unit, the supporting part being configured to be capable of supporting wheels of a car; the base and the supporting part are both disposed at a first side of the moving unit, and the base is located at an outer side of the supporting part. When in use, four sets of the portable car lifting mechanisms can be used to lift the entire car, so as to avoid the problem of being flooded due to standing water.

### CROSS-REFERENCE TO RELATED APPLICATIONS

This application is a bypass Continuation application of International Patent Application No. PCT/CN2023/123584, filed Oct. 9, 2023, which claims priority to Chinese Patent Application No. 202211241274.0, filed Oct. 11, 2022; the disclosures of all of which are incorporated herein by reference in their entirety. This application also claims priority to Chinese Patent Application No. 202520255786.5, filed Feb. 17, 2025, and Chinese Patent Application No. 202520255912.7, filed Feb. 17, 2025; the disclosures of all of which are incorporated herein by reference in their entirety.

### TECHNICAL FIELD

The present application relates to a lifting apparatus, in particular to a portable car lifting mechanism and apparatus, and a system.

### BACKGROUND

With the improvement of living standard of residents, more and more families have purchased cars.

However, as special movable property, cars have high value. If they are damaged, it will be a considerable loss for families. In daily life, the most serious damage to cars is caused by flooding except for collision. Car damage caused by collision is a man-made loss and can be generally avoided by paying attention to driving safety, while car damage caused by flooding is mainly affected by adverse weather conditions such as rainstorms.

Currently, to solve the problem of cars being flooded, people usually have to park their cars at higher ground before a predicated rainstorm. However, the available high-altitude parking lots are limited. Therefore, some people have come up with the idea of parking their cars on elevated bridges before the rainstorm. This behavior not only affects traffic safety, but also leads to administrative penalties.

It can be seen that, currently, there is an urgent need to solve the problem of cars being flooded for car owners.

### SUMMARY

To solve the problem of cars being flooded, according to an aspect of the present application, a portable car lifting mechanism is provided.

The portable car lifting mechanism includes a base; a moving unit fixedly provided relative to the base; and a supporting part capable of moving relative to the base along a vertical direction under the driving of the driving unit, the supporting part being configured to be capable of supporting wheels of a car; the base and the supporting part are disposed at the same side of the moving unit, and the base is located at an outer side of the supporting part.

When using the portable car lifting mechanism, four sets of the portable car lifting mechanisms need to be used simultaneously. Firstly, the relative positions of the base and the supporting part are adjusted by the moving unit to make the two basically on the same plane, and the supporting part is placed under the wheels of the car, and then the moving unit can be driven, by the driving unit, to drive the supporting part which supports the wheels to do an ascending movement relative to the base, thereby lifting the entire car to avoid the problem of being flooded due to standing water. In the solution of the present application, the base and the supporting part are disposed at the same side of the moving unit, while the base is located at the outer side of the supporting part. Therefore, such structure design enables ensuring the operation stability of the portable car lifting mechanism while maintaining the structure compactness of the portable car lifting mechanism.

According to an aspect of the present application, a portable car lifting apparatus is provided.

The portable car lifting apparatus includes the above portable car lifting mechanism, and further includes a driving unit having a locking function, the driving unit being capable of driving the moving unit to drive the supporting part to move along the vertical direction. The portable car lifting apparatus of the present application can drive, by the driving unit, the moving unit to drive the supporting part to move along the vertical direction to a desired position and then be kept locked, thereby reducing the risk of the car being flooded due to rainstorm standing water.

According to an aspect of the preset application, a car lifting system is provided. The car lifting system includes a master control module and four sets of the above portable car lifting apparatus. The master control module is configured to be capable of controlling the start and stop of a control module. Therefore, controlled by the master control module, the four sets of portable car lifting apparatus can start together or one of the four sets of portable car lifting apparatus can start.

### BRIEF DESCRIPTION OF THE DRAWINGS

FIG. 1 is a structural schematic diagram of a portable car lifting mechanism of a first embodiment of the present disclosure;

FIG. 2 a structural schematic diagram of a cross section of the portable car lifting mechanism shown in FIG. 1;

FIG. 3 a structural schematic diagram of the portable car lifting mechanism shown in FIG. 1, in a raised state;

FIG. 4 a structural schematic diagram of the portable car lifting mechanism shown in FIG. 1, in a disassembled state;

FIG. 5 is a structural schematic diagram of a portable car lifting mechanism of a second embodiment of the present disclosure;

FIG. 6 a structural schematic diagram of the portable car lifting mechanism shown in FIG. 5, in a disassembled state;

FIG. 7 is a structural schematic diagram of another view of the portable car lifting mechanism shown in FIG. 6;

FIG. 8 a structural schematic diagram of a portable car lifting mechanism of a third embodiment of the present disclosure, in a disassembled state;

FIG. 9 is a structural schematic diagram of a portable car lifting mechanism of a fourth embodiment of the present disclosure;

FIG. 10 a structural schematic diagram of the portable car lifting mechanism shown in FIG. 9, in a first disassembled state;

FIG. 11 a structural schematic diagram of the portable car lifting mechanism shown in FIG. 9, in a second disassembled state;

FIG. 12 is a structural schematic diagram of the portable car lifting mechanism shown in FIG. 9, in a stored state after disassembly;

FIG. 13 is a structural schematic diagram of a portable car lifting apparatus of a first embodiment of the present disclosure;

FIG. 14 a structural schematic diagram of a cross section of the portable car lifting apparatus shown in FIG. 13;

FIG. 15 a structural schematic diagram of the portable car lifting apparatus shown in FIG. 13, in a disassembled state;

FIG. 16 is a structural schematic diagram of a cross section of the portable car lifting apparatus shown in FIG. 13, omitting a base, a supporting part and a moving unit;

FIG. 17 a structural schematic diagram of the portable car lifting apparatus shown in FIG. 16, in a disassembled state;

FIG. 18 is a structural schematic diagram of a sliding block body of an embodiment of the present disclosure;

FIG. 19 is a structural schematic diagram of another view of the sliding block body shown in FIG. 18;

FIG. 20 is a structural schematic diagram of a cross section of the sliding block body shown in FIG. 19, taken along A-A;

FIG. 21 is a structural schematic diagram of the sliding block body shown in FIG. 18, in a disassembled state;

FIG. 22 is a structural schematic diagram of a portable car lifting apparatus of a second embodiment of the present disclosure;

FIG. 23 is a structural schematic diagram of a cross section of the portable car lifting apparatus shown in FIG. 22, taken along B-B;

FIG. 24 is a structural schematic diagram enlarged at C of the portable car lifting apparatus shown in FIG. 23;

FIG. 25 is a structural schematic diagram of the portable car lifting apparatus shown in FIG. 22, in a first disassembled state;

FIG. 26 is a structural schematic diagram enlarged at D of the portable car lifting apparatus shown in FIG. 25;

FIG. 27 is a structural schematic diagram of another view of the portable car lifting apparatus shown in FIG. 25, in a disassembled state;

FIG. 28 is a structural schematic diagram enlarged at E of the portable car lifting apparatus shown in FIG. 27;

FIG. 29 is a structural schematic diagram of the portable car lifting apparatus shown in FIG. 22, in a second disassembled state;

FIG. 30 is a structural schematic diagram of a car lifting system of an embodiment of the present disclosure.

### DETAILED DESCRIPTION

It is to be noted that embodiments of the present application and features in the examples can be combined with each other without conflict.

It is to be also noted that relational terms herein such as “first” and “second” are merely used to distinguish one entity or operation from another entity or operation, and do not necessarily require or imply that there is any such actual relation or order between these entities or operations. Moreover, terms “include” and “comprise” include not only those elements but also other elements not explicitly listed, or also include elements inherent to such process, method, article or device. Without more restrictions, the elements defined by the phrase “comprising . . . ” do not exclude the presence of other identical elements in the process, method, article or device that includes the stated elements. The terms used herein are generally terms commonly used by those skilled in the art. If there is any inconsistency with commonly used terms, the terms used herein shall prevail.

To make the purpose, technical solution and advantages of the embodiments of the present disclosure clearer, the technical solutions in the embodiments of the present disclosure will be clearly and completely described below in conjunction with the drawings in the embodiments of the present disclosure. Obviously, the described embodiments are part of, rather than all of, the embodiments of the present disclosure. Based on the embodiments of the present disclosure, all other embodiments obtained by those of ordinary skills in the art without any creative effort fall within the protection scope of the present disclosure.

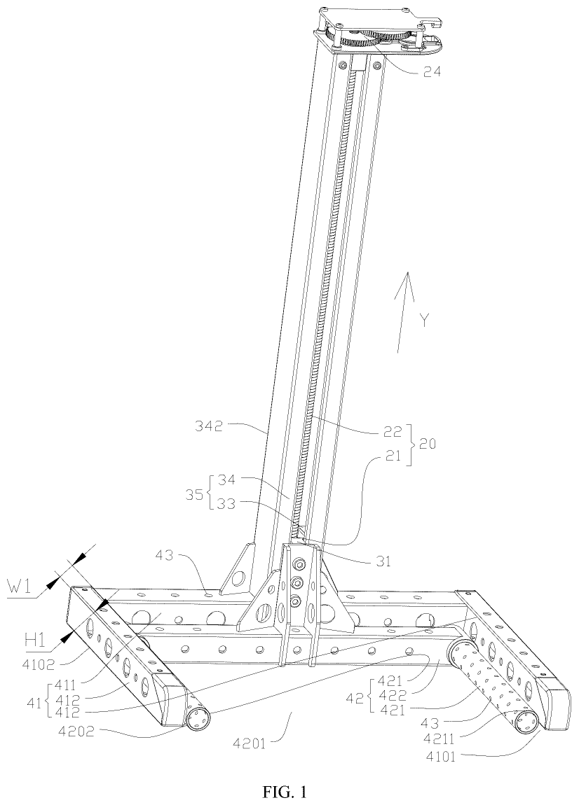

FIG. 1 to FIG. 4 schematically illustrate a portable car lifting mechanism according to a first embodiment of the present disclosure.

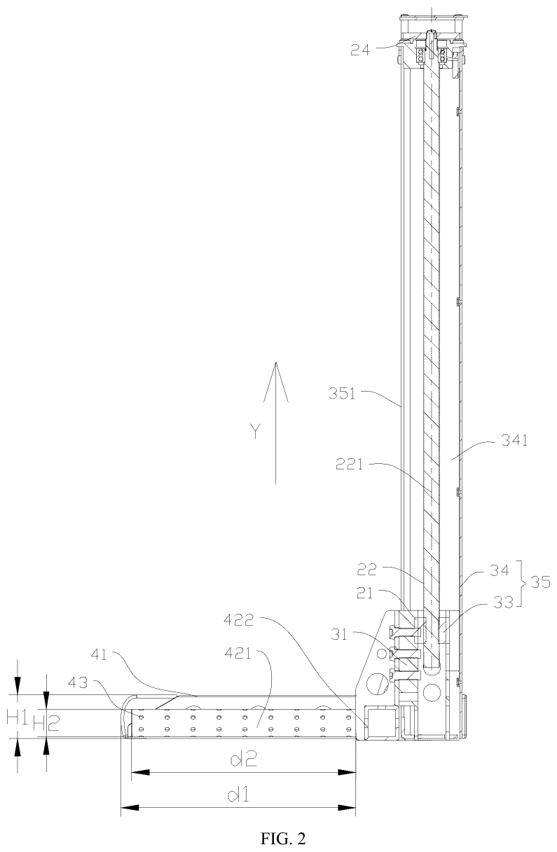

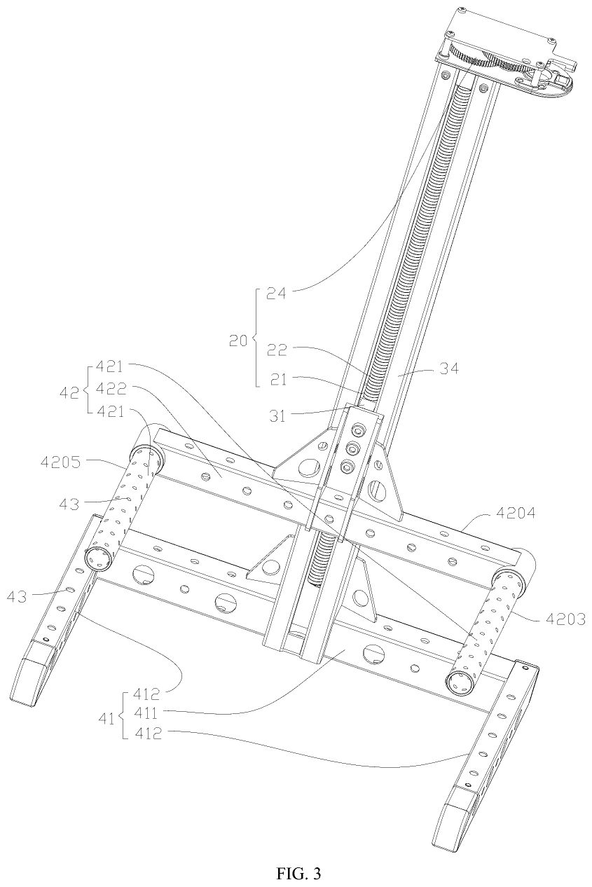

As shown in FIG. 1 to FIG. 4, the portable car lifting mechanism includes a base 41, a moving unit 35 and a supporting part 42. The moving unit 35 is fixedly disposed relative to the base 41, and the moving unit 35 is configured to be capable of driving the supporting part 42 to move relative to the base 41 along a vertical direction Y. The supporting part 42 is configured to be capable of placing wheels of a car. The base 41 and the supporting part 42 are both disposed at the same side of the moving unit 35, for example, as shown in FIG. 2, the base 41 and the supporting part 42 are both disposed at a first side 351 of the moving unit 35; and the base 41 is located at an outer side of the supporting part 42, for example, as shown in FIG. 3, one part of the base 41 is located at a first outer side 4203 of the supporting part 42, and another part of the base 41 is located at a second outer side 4204 of the supporting part 42, and another part of the base 41 is located at a third outer side 4205 of the supporting part 42.

As one of the embodiments of the moving unit 35, as shown in FIG. 1 and FIG. 2, the moving unit 35 includes a guide rail 34 and sliding block bodies 33 that are adapted to each other. The guide rail 34 is disposed along the vertical direction Y. The base 41 is relatively fixed on the guide rail 34. The supporting part 42 is disposed on the sliding block bodies 33. The moving unit 35 can also be implemented by other structures that can define the motion trajectory of the supporting part 42. As long as a structure that can define the motion trajectory of the supporting part 42 can serve as the moving unit 35 in the present disclosure, the specific implementation of the moving unit 35 is not limited in the present disclosure unless otherwise emphasized.

When using the portable car lifting mechanism, four sets of the portable car lifting mechanisms need to be used simultaneously. Firstly, relative positions of the base 41 and the supporting part 42 are adjusted by the moving unit 35 to make the two basically on the same plane, and the supporting part 42 is placed under wheels of a car, and then the moving unit 35 can be driven, by the driving unit 20 having a locking function, to drive the supporting part 42 which supports the wheels to do an ascending movement relative to the base 41, thereby lifting the entire car to avoid the problem of being flooded due to standing water. In the solution of this example of the present application, the base 41 and the supporting part 42 are disposed at the same side of the moving unit 35, while the base 41 is located at the outer side of the supporting part 42. Therefore, such a structure design ensures the operation stability of the portable car lifting mechanism while maintaining the structure compactness of the portable car lifting mechanism.

As one of the preferred embodiments of the guide rail 34, as shown in FIG. 1 to FIG. 4, the guide rail 34 is hollow channel steel to reduce the weight of the guide rail 34, and ensure the strength of the lifting mechanism, thereby preventing the guide rail 34 from bending and deforming when driving the car to ascend and descend. Further, the sliding block bodies 33 are located at the hollow part of the channel steel (i.e., in a first accommodating cavity 341 of the guide rail 34 as shown in FIG. 2) to achieve the structural compactness.

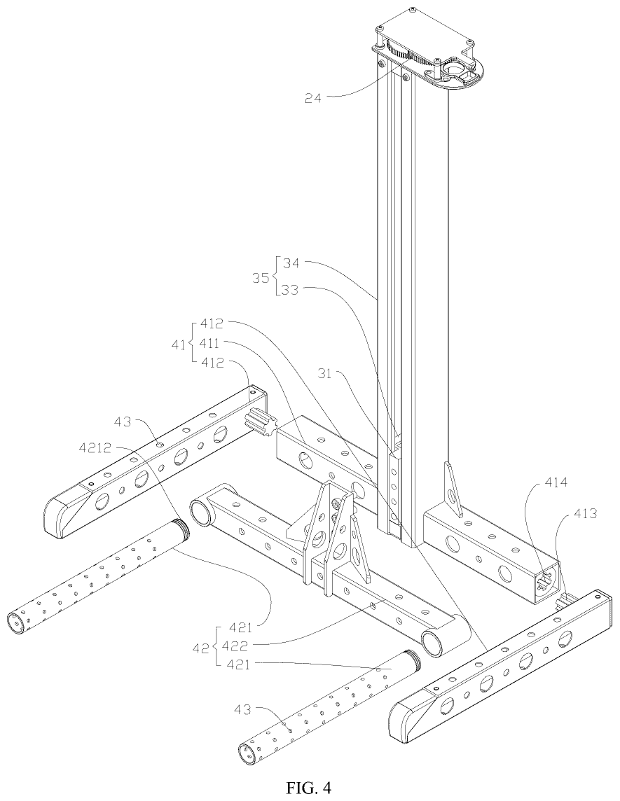

As one of the preferred embodiments of the base 41 and the supporting part 42, as shown in FIG. 1, FIG. 3 and FIG. 4, the base 41 and the supporting part 42 are both made of hollow tubes, and first through holes 43 are integrally formed or processed in both the base 41 and the supporting part 42 to further ensure the lightweight of the portable car lifting mechanism, and the first through holes 43 formed in the supporting part 42 can also play a role in increasing the friction of a contact surface. In other possible embodiments, it can also be that either of the base and the supporting part is made of the hollow tube, while it can be that the first through holes 43 is formed in the tube or no through hole is formed in the tube.

As another preferred embodiment of the base 41 and the supporting part 42, as shown in FIG. 1 and FIG. 2, a height H1 of the base 41 is greater than a height H2 of the supporting part 42 to improve road holding of the base 41.

As another preferred embodiment of the base 41 and the supporting part 42, as shown in FIG. 1 to FIG. 3, the base 41 and the supporting part 42 are both configured as U-shaped structures to further ensure the lightweight of the portable car lifting mechanism. Preferably, as shown in FIG. 1 and FIG. 3, openings of the U-shaped structures are all provided as facing towards one side away from the moving unit 35. For example, as shown in FIG. 1, a first opening 4101 of the base 41 of the U-shaped structure is provided as facing toward one side away from the moving unit 35, and a second opening 4201 of the supporting part 42 of the U-shaped structure is provided as facing toward one side away from the moving unit 35. The base 41 and the supporting part 42 of the U-shaped structures can be inserted into both front and rear sides of the wheels after the car is parked in place, so that when the supporting part 42 is driven, by the moving unit 35, to do an ascending movement relative to the base 41, the supporting part 42 can drive the wheel to rise together without the need to run the car onto the portable car lifting mechanism put in place, which is more flexible and convenient in operation. Preferably, as shown in FIG. 3 and FIG. 4, the supporting part 42 includes a connecting part 422 and contact parts 421, the connecting part 422 being detachably connected to the moving unit 35. When the moving unit 35 includes a guide rail 34 and sliding block bodies 33 that are adapted to each other, the connecting part 422 is detachably disposed relative to the sliding block bodies 33. The contact part 421 is used for being in contact with the wheel, and two contact parts 421 are disposed and detachably connected to both ends of the connecting part 422 respectively to form a U-shaped structure through the connection between the connecting part 422 and the contact parts 421. Preferably, as shown in FIG. 3 and FIG. 4, the base 41 includes a connecting tube 411 and side tubes 412, the connecting tube 411 being fixed relative to the moving unit 35. When the moving unit 35 includes a guide rail 34 and sliding block bodies 33 that are adapted to each other, the connecting tube 411 is fixedly disposed relative to the guide rail 34, for example, the connecting tube 411 is installed on the guide rail 34. Two side tubes 412 are disposed and detachably connected to both ends of the connecting tube 411 respectively to form a U-shaped structure through the connection between the connecting tube 411 and the side tubes 412. Therefore, when the portable car lifting mechanism is not used, the contact parts 421 can be disassembled from the connecting part 422, and the side tubes 412 can also be disassembled from the connecting tube 411, so that the portable car lifting structure after disassembly can be easily stored, for example, in a trunk of the car. Further, with continued reference to FIG. 4, the contact parts 421 are in threaded connection with the connecting part 422, and the connecting tube 411 is in inserted connection with the side tubes 412 via spline shafts 413. In some embodiments, as shown in FIG. 3 and FIG. 4, the connecting tube 411 and the side tubes are of linear structures, the two side tubes being connected to two free ends, away from each other, of the connecting tube 411 to form the U-shaped base 41. In some embodiments, as shown in FIG. 3 and FIG. 4, the contact parts 421 and the connecting part 422 are of linear structures, the two contact parts 421 being connected to two free ends, away from each other, of the connecting part 422 to from the U-shaped supporting part 42. In other possible embodiments, it can also be that merely the contact parts 421 are in threaded connection with the connecting part 422, or merely the connecting tube 411 is in inserted connection with the side tubes 412 via the spline shafts 413. For example, the spline shaft 413 is integrally formed, processed or connected with one of the connecting tube 411 and the side tube 412, and a spline slot 414 adapted to the spline shaft 413 is integrally formed or processed on the other. Therefore, the contact parts 421 and the side tubes 412 can be detachably connected to the connecting part 422 and the connecting tube 411 respectively without the aid of any external tool, which is convenient in operation. Moreover, the contact parts 421 and the connecting part 422 are connected via threads, which can ensure the stability for the supporting part 42 formed to support the wheels, thereby preventing the contact parts 421 from falling off the connecting part 422 during the ascending and descending movement of the supporting part 42. The connecting tube 411 and the side tubes 412 are in inserted connection by splines, which can not only improve the efficiency of the connection between the two, but also prevent the two from rotating relative to each other after connection, thereby ensuring the stability of the base 41. In addition, the contact parts 421 and the connecting part 422, as well as the connecting tube 411 and the side tubes 412 are all disposed in a detachable connection manner, which can also further ensure the structural compactness of the car lifting mechanism in a non-use state. Further, as shown in FIG. 1 and FIG. 2, a distance d1 from the side tubes 412 to the connecting tube 411 is greater than a distance d2 from the contact parts 421 to the connecting part 422 to ensure the operation stability of the portable car lifting mechanism. Particularly, at least one of the connecting tube 411, the side tubes 412, the contact parts 421 and the connecting part 422 is a seamless steel tube to ensure the strength of the connecting tube 411, the side tubes 412, the contact parts 421 and the connecting part 422. Optionally, in other possible embodiments, it can also be that merely either of the base 41 and the supporting part 42 is configured as a U-shaped structure.

As one of the preferred embodiments of the contact part 421, as shown in FIG. 1 to FIG. 4, a first top 4211 of the contact part 421 is configured as an arc shape, so that a force applied by the contact part 421 onto the wheel can be distributed more evenly, preventing the wheel from being embedded in the contact part 421. It is to be noted that the first top 4211 here refers to an end part of the contact part 421 that is in contact with the wheel for supporting the wheel when in use. Preferably, the contact part 421 is of a cylindrical tubular structure, so that the contact part 421 connected to the connecting part 422 is always in contact with the wheel via an arc face, and particularly, even if the contact part 421 is connected to the connecting part 422 via threads 4212, the contact between the wheel and the arc face of the contact part 421 will not be affected by the depth of the thread screwing.

As one of the preferred embodiments of the connecting tube 411 and the side tubes 412, as shown in FIG. 1, FIG. 3 and FIG. 4, the connecting tube 411 and the side tubes 412 are square tubes with square cross sections to improve the road holding of the base 41 formed by connection of the side tubes 412 to the connecting tube 411. Preferably, as shown in FIG. 1, a width W1 of the cross section of the side tube 412 is smaller than a height H1 thereof. Since the base 41 and the supporting part 42 are both disposed at the same side of the moving unit 35, setting the height of the side tube 412 to be higher than the width thereof can improve the torsional resistance capability of the base 41 formed.

As one of the preferred embodiments of the supporting part 42, as shown in FIG. 4, the supporting part 42 is detachably connected to the moving unit 35, so that when the portable car lifting mechanism is not used, the supporting part 42 can be disassembled from the moving unit 35 for easy storage.

Preferably, a rust-proof coating is provided on the surface of at least one of the base 41, the supporting part 42 and the guide rail 34. As shown in FIG. 1, a rust-proof coating is provided on a first surface 4102 of the base 41, and a rust-proof coating is provided on a second surface 4202 of the supporting part 42, and a rust-proof coating is provided on a third surface 342 of the guide rail 34. For example, the surface of at least one of the base 41, the supporting part 42 and the guide rail 34 is galvanized to prolong the service life of the base 41, the supporting part 42 and the guide rail 34.

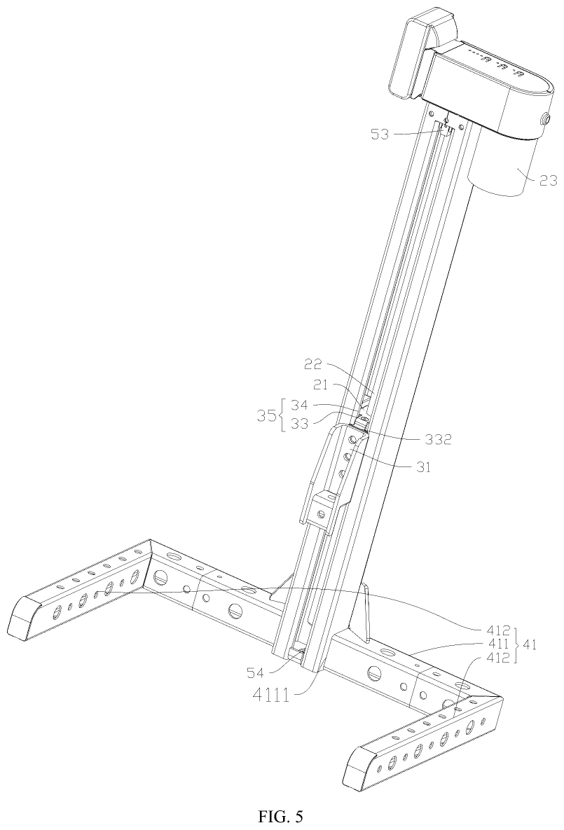

FIG. 5 to FIG. 7 schematically illustrate a portable car lifting mechanism according to a second embodiment of the present disclosure. The main difference between the portable car lifting mechanism of this embodiment and the portable car lifting mechanism of the first embodiment lies in different implementation of the bases 41. The details are as follows.

As shown in FIG. 5 to FIG. 7, the base 41 of the portable car lifting mechanism includes a connecting tube 411 and side tubes 412. One connecting tube 411 is provided; two side tubes 412 are provided, and the side tubes 412 are of L-shaped structures. The two side tubes 412 are detachably connected to a first free end 4112 and a second free end 4113 of the connecting tube 411 respectively to form the U-shaped base 41.

Since the U-shaped base 41 is formed by detachable connection of the one connecting tube 411 to the two L-shaped side tubes 412, the length of the connecting tube 411 can be shorter than that of an intermediate tube of the U-shaped base 41. When the portable car lifting mechanism is not used, the side tubes 412 can be disassembled from the connecting tube 411. The connecting tube 411 and the side tubes 412 that are disassembled, when stacked together, occupy a smaller width, enabling the portable car lifting mechanism with a three-dimensional structure after disassembly to form a two-dimensional structure, so as to be easily stored, for example, in the trunk of the car.

In some preferred embodiments, the connecting tube 411 is non-rotatably connected to the side tubes 412. Therefore, the stability of the base 41 formed by connection of the connecting tube 411 to the side tubes 412 can be ensured.

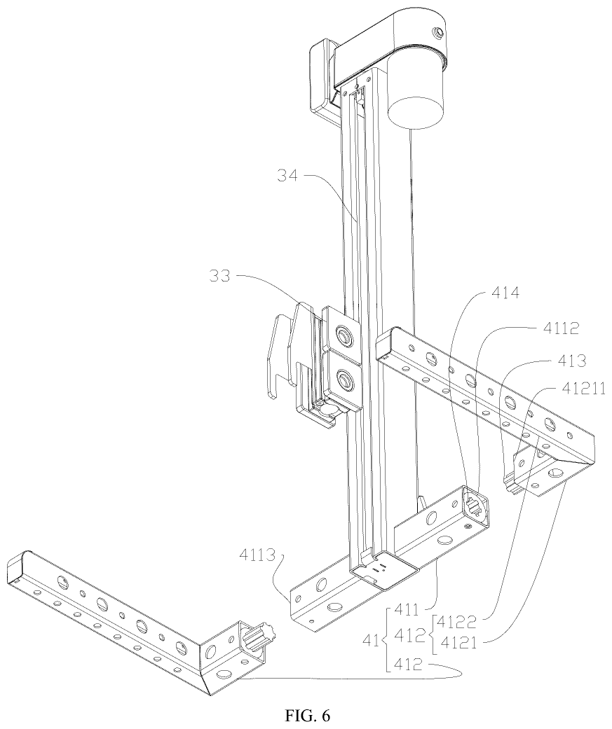

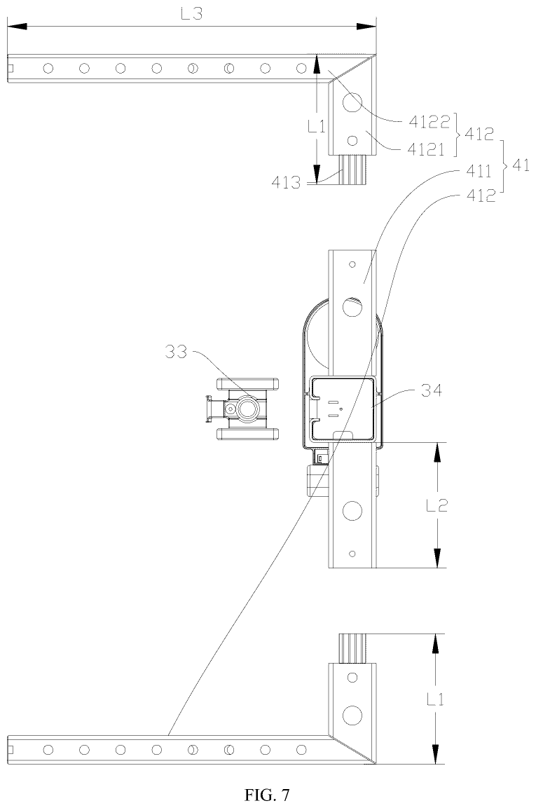

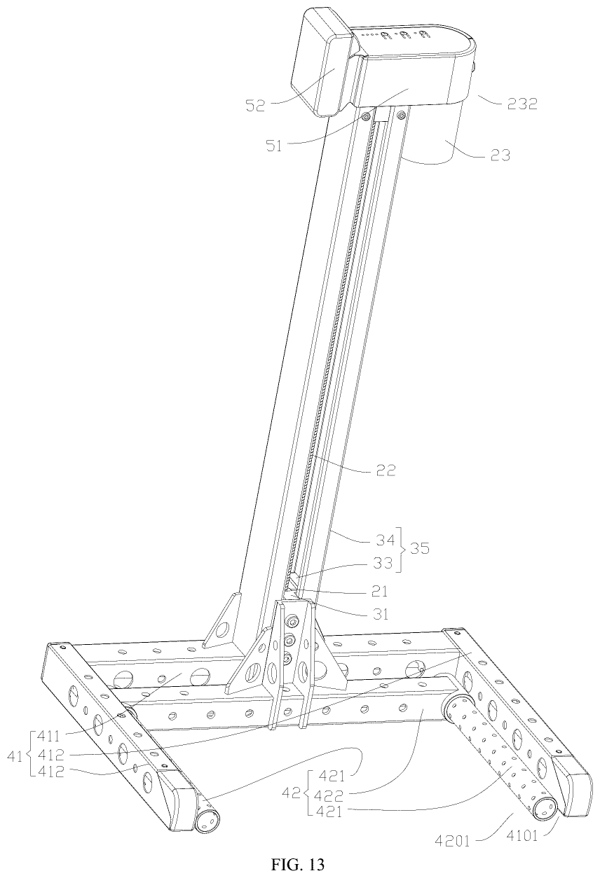

As one of the embodiments in which the connecting tube 411 is non-rotatably connected to the side tubes 412, as shown in FIG. 6 and FIG. 7, the connecting tube 411 and the side tubes 412 are non-rotatably connected via spline shafts 413 and spline slots 414. Therefore, the connecting tube 411 and the side tubes 412 can be detachably connected without the aid of any external tool, which is convenient in operation. Preferably, the side tube 412 includes a short side 4121 and a long side 4122 that are connected in sequence to form an L-shaped structure. The connecting tube 411 is linear and an intermediate part 4111 thereof is used to be disposed (for example, in an integrated molding, processing or connection manner) on the guide rail 34 of the portable car lifting mechanism. The spline shaft 413 is disposed on a third free end 41211 of the short side 4121, and the spline slots 414 are formed in a first free end 4112 and a second free end 4113 of the connecting tube 411, and the sum of the lengths of the short side 4121 and the spline shaft 413 is L1, and the length from the first free end 4112 or the second free end 4113 of the connecting tube 411 to the guide rail 34 is L2, and the absolute value of the difference between L1 and L2 is smaller than 10 mm. When the connecting tube 411 is connected to the side tubes 412, the L-shaped short side 4121 and the connecting tube 411 are in an extension line of the same straight line, so that a U-shaped structure is formed after the first free end 4112 and the second free end 4113 of the connecting tube 411 are connected to the side tubes 412. After the side tube 412 is disassembled from the connecting tube 411, the short side 4121 of the side tube 412 can be placed parallel to the connecting tube 411, and the long side 4122 of the side tube 412 can be placed parallel to the guide rail 34 (as shown in FIG. 13), enabling the base 41 and the guide rail 34 that are disassembled to be packaged in a rectangular container with the smallest volume. Preferably, the connecting tube 411 is perpendicular to an extension direction of the guide rail 34. To ensure that the guide rail 34, when in the vertical direction, can be stably supported by the base 41, the bottom face of the base 41 is configured as a plane.

As another embodiment in which the connecting tube 411 is non-rotatably connected to the side tubes 412, the connecting tube 411 and the side tubes 412 are connected by a pin.

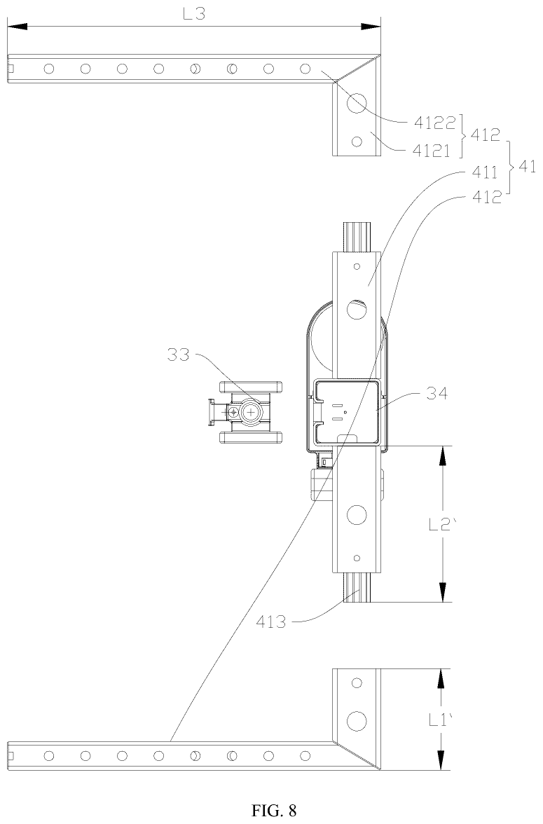

FIG. 8 schematically illustrate a portable car lifting mechanism according to a third embodiment of the present disclosure. The main difference between the portable car lifting mechanism of this embodiment and the portable car lifting mechanism of the second embodiment lies in different specific implementation in which the connecting tube 411 and the side tubes 412 are non-rotatably connected via the spline shafts 413 and the spline slots 414. The details are as follows.

As shown in FIG. 8, the spline shaft 413 is not disposed at the free end of the short side 4121, but at the free end of the connecting tube 411. The spline slot 414 is not formed in the free end of the connecting tube 411, but in the free end of the short side 4121. The length of the short side 4121 is L1′, and the length from the free end of the spline shaft 414 to the guide rail 34 is L2′, and the absolute value of the difference between L1′ and L2′ is smaller than 10 mm.

Therefore, after the connecting tube 411 is connected to the side tubes 412, a U-shaped structure can be formed. After the side tubes 412 are disassembled from the connecting tube 411, the short side 4121 of the side tube 412 can be placed parallel to the connecting tube 411, and the long side 4122 of the side tube 412 can be placed parallel to the guide rail 34, so that the base 41 and the guide rail 34 that are disassembled, when stacked together, occupy a smaller width for easy storage.

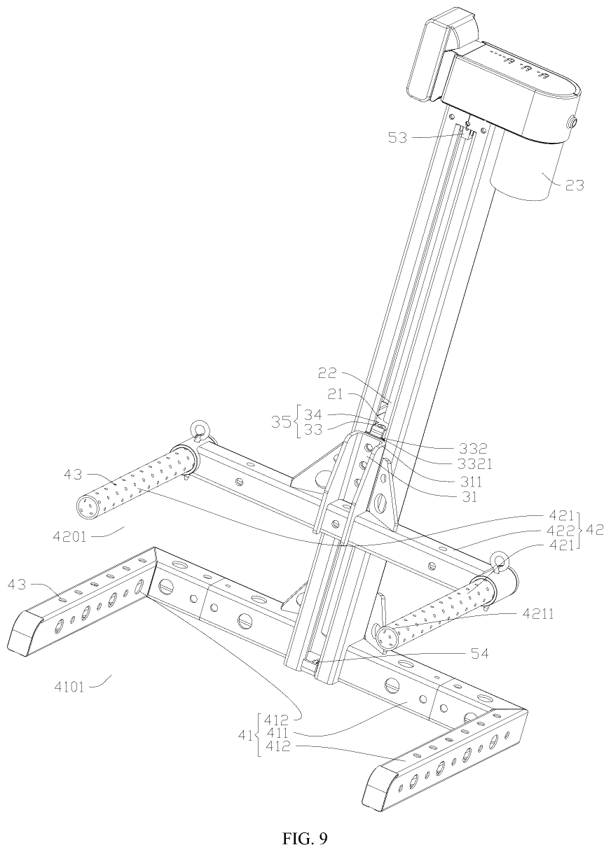

FIG. 9 to FIG. 12 schematically illustrate a portable car lifting mechanism according to a fourth embodiment of the present disclosure. The main difference between the portable car lifting mechanism of this embodiment and the portable car lifting mechanism of the second embodiment lies in different implementation of the supporting parts 42. The details are as follows.

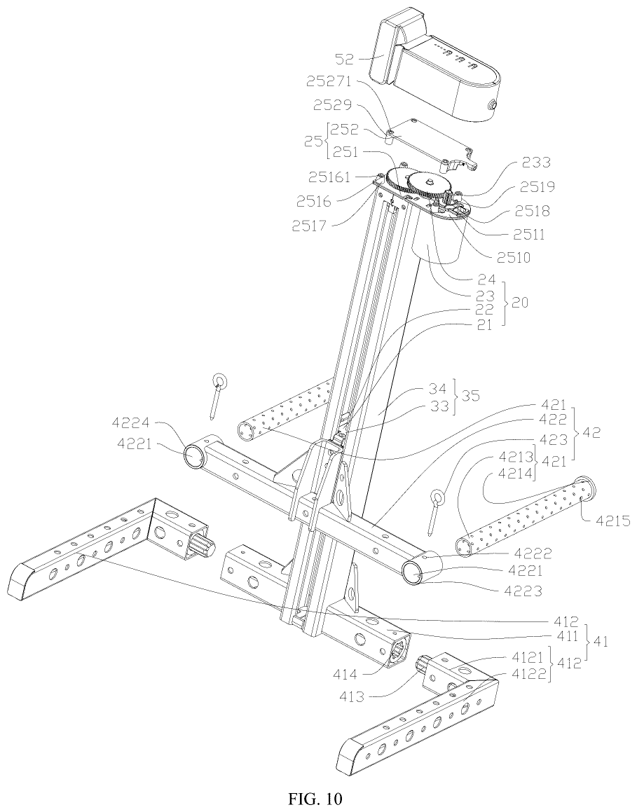

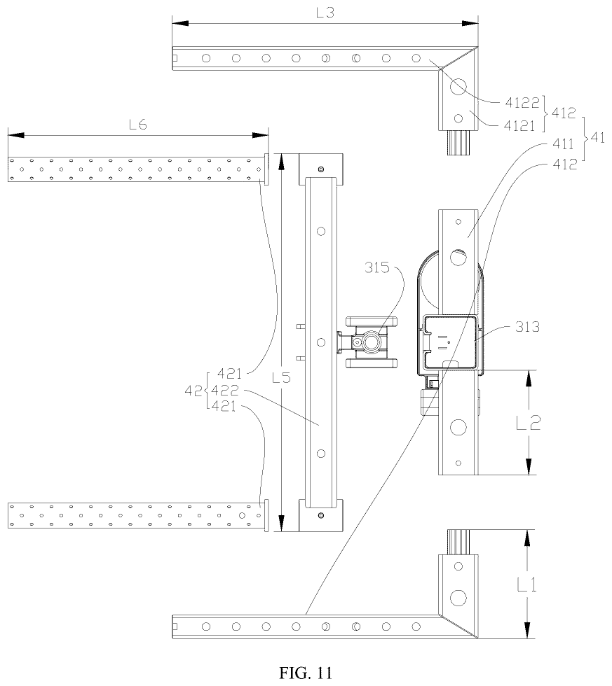

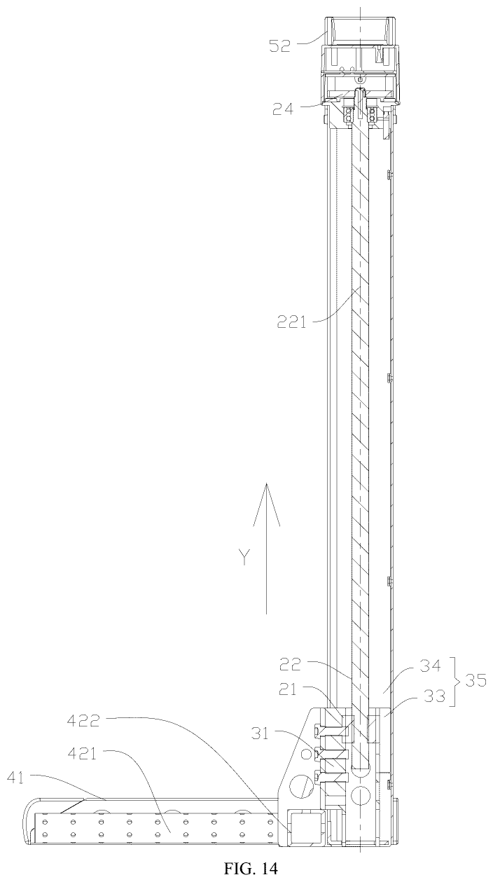

As shown in FIG. 9 and FIG. 10, a fourth free end 4223 and a fifth free end 4224 of the connecting part 422 are both integrally formed or processed with second accommodating cavities 4221. One end of each of the two contact parts 421 is sleeved in the two second accommodating cavities 4221 of the connecting part 422, and the contact part 421 and the connecting part 422 are detachably connected via a pin 423. Specifically, a second through hole 4222 adapted to the pin 423 is integrally formed or processed in the connecting part 422, and a fourth through hole 4215 adapted to the pin 423 is integrally formed or processed in the contact part 421. Therefore, when the portable car lifting mechanism is not used, the contact parts 421 can be disassembled from the connecting part 422, and the side tubes 412 can also be disassembled from the connecting tube 411, enabling the portable car lifting mechanism with a three-dimensional structure after disassembly to form a two-dimensional structure, so as to be easily stored, for example, in the trunk of the car. Moreover, the contact parts 421 and the connecting part 422 can be detachably connected without the aid of any external tool, which is convenient in operation. Moreover, the contact part 421 and the connecting part 422 are connected by the pin 423, which can ensure the stability for the supporting part 42 formed to support the wheels, thereby preventing the contact parts 421 from falling off the connecting part 422 during the ascending and descending movement of the supporting part 42. Preferably, the second accommodating cavity 4221 is a through hole. The contact part 421 includes an insertion part 4213 adapted to the second accommodating cavity 4221, and a blocking part 4214 provided at one end of the insertion part 4213. The diameter of the blocking part 4214 is greater than that of the second accommodating cavity 4221, so that the blocking part 4214 can limit the limit position where the insertion part 4213 is inserted to the second accommodating cavity 4221, facilitating the connection between the contact parts 421 and the connecting part 422. Preferably, as shown in FIG. 11, at least one of the length L5 of the connecting part 422 and the length L6 of the contact part 421 is smaller than the length L4 of the guide rail 34 to ensure the compactness for placement next to the guide rail 34 after the contact part 421 is disassembled from the connecting part 422 and the connecting part 422 is disassembled from the sliding block body 33 (as shown in FIG. 14).

In some preferred embodiments, as shown in FIG. 9, the supporting part 42 is connected to the sliding block body 33 via a first connecting piece 31, and one end, same as a first top 4211 of the contact part 421, of one side, connected to the connecting piece 31, of the sliding block body 33 is configured to have a first step 332, and a first upper surface 3321 of the first step 332 is flush with a second upper surface 311 of the first connecting piece 31.

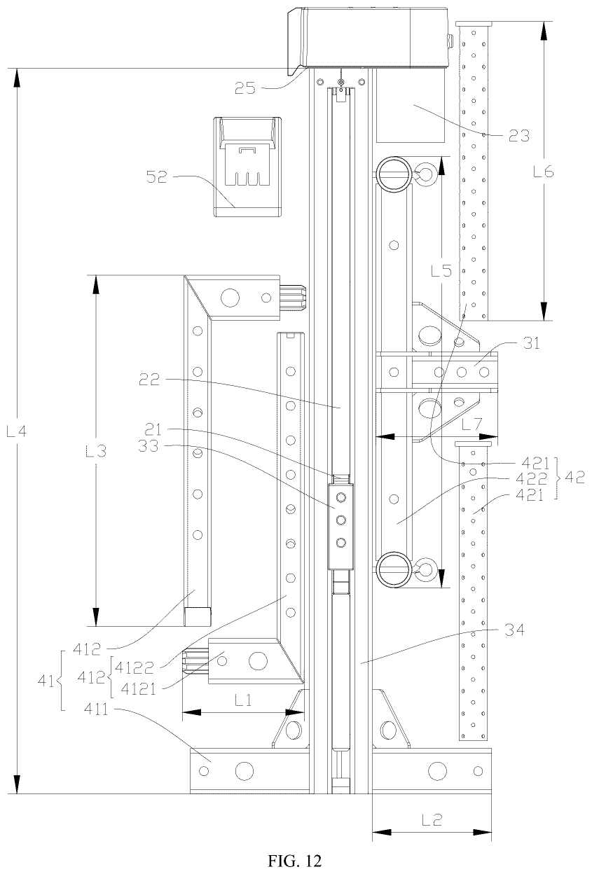

As shown in FIG. 11 and FIG. 12, preferably, the absolute value of the difference between the length L7 of the first connecting piece 31 and L2 is smaller than 10 mm. The absolute value of the difference between twice the length L6 of the contact part 421 and the length L4 of the guide rail 34 is smaller than 10 mm; the length L5 of the connecting part 422 is smaller than the length L4 of the guide rail 34. This enables the supporting part 42 and the guide rail 34 that are disassembled, when stacked together, to be packaged in a rectangular container with the smallest volume. Preferably, a length L3 of the long side 4122 of the side tube 412 is smaller than a length L4 of the guide rail 34 to ensure the compactness for placement next to the guide rail 34 after the side tube 412 is disassembled from the connecting tube 411.

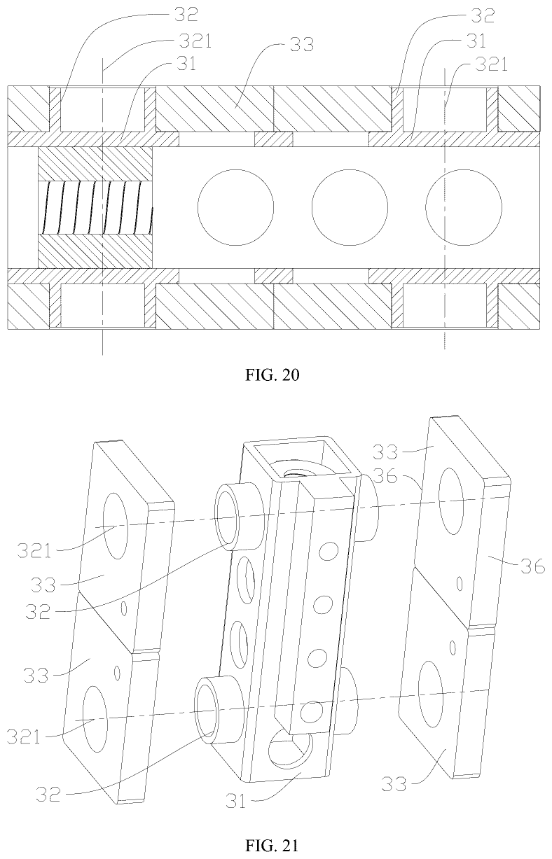

FIG. 13 to FIG. 21 schematically illustrate a portable car lifting apparatus according to a first embodiment of the present application.

As shown in FIG. 13 to FIG. 15, the portable car lifting apparatus includes a driving unit 20 and the above portable car lifting mechanism. The driving unit 20 is configured to be capable of driving the moving unit 35 to drive the supporting part 42 to move along the vertical direction Y, and the driving unit 20 has a locking function. When in use, the moving unit 35 can drive the supporting part 42 to move along the vertical direction Y to a desired position under the driving of the driving unit 20, and the supporting part is kept locked at the desired position through the locking function of the driving unit 20, thereby lifting the entire car to a desired height, reducing the risk of the car being flooded due to rainstorm standing water.

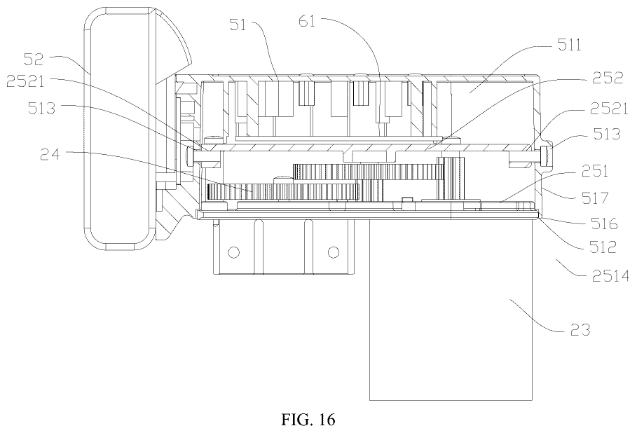

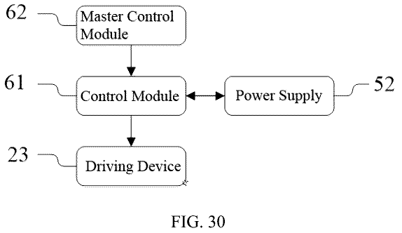

As one of the embodiments of the driving unit 20, as shown in FIG. 13 to FIG. 15, the driving unit 20 includes a first screw rod 22 and a first nut 21 that are adapted to each other. The first screw rod 22 can be rotatably disposed, around a first axis 221 thereof, relative to the moving unit 35, and the first screw rod 22 is disposed along the direction Y in which the moving unit 35 drives the supporting part 42 to move. The first nut 21 is disposed on the moving unit 35. Therefore, even if the first screw rod 22 stops rotating, since the first nut 21 is connected to the first screw rod 22 by threads, such connection mode can keep the first nut 21 at the position, which will not change over time (i.e., having a locking function) until the first screw rod 22 rotates again. Preferably, the first screw rod 22 is rotatably disposed relative to the guide rail 34 of the moving unit 35, and the first screw rod 22 is disposed along an extension direction Y of the guide rail 34, the first nut 21 being disposed on the sliding block body 33, adapted to the guide rail 34, of the moving unit 35. Further, the guide rail 34 is hollow channel steel, and the first screw rod 22 and the first nut 21 are located at a hollow part of the channel steel to achieve the structural compactness. In some embodiments, the hollow part of the channel steel is also provided with a fixed seat located at the bottom, and the bottom of the first screw rod is inserted in a suspended or bottom-fixed manner into the fixed seat, thereby fixing the first screw rod, ensuring the stability thereof during use. Preferably, the driving unit 20 further includes a driving device 23 for driving the first screw rod 22 to move. Exemplarily, the driving device 23 is a rotary motor. As shown in FIG. 16 and FIG. 30, the driving unit 20 further includes a control module 61 for driving the start and stop of the driving device 23. At least one of the driving device 23 and the control module 61 can be detachably disposed relative to the guide rail 34. Therefore, the start and stop of the driving device 23 can be controlled by the control module 61 so as to control the rotation state of the first screw rod 22, and then the first nut 21 adapted onto the first screw rod 22 can be controlled as needed to drive the sliding block body 33 to move along the extension direction of the guide rail 34. Moreover, since the control module 61 and the driving device 23 can be removed from the guide rail 34, even if the portable car lifting mechanism is used outdoors in rainy weather, the control module 61 and the driving device 23 can be removed from the guide rail 34 to avoid damage to the control module 61 and the driving device 23 caused by rainwater. At the same time, since the first nut 21 that drives the sliding block body 33 to do the ascending and descending movement is adapted onto the first screw rod 22, even if the control module 61 and the driving device 23 are removed from the guide rail 34, the position of the first nut 21 on the first screw rod 22 will not be affected, thereby ensuring the stability for the portable car lifting apparatus to lift a car. Preferably, as shown in FIG. 16, the control module 61 is connected to a cover 51, and the cover 51 is detachably connected to the guide rail 34. Therefore, not only the control module 61 can be prevented, by the cover 51, from getting wet, but also a control panel can be arranged on the surface of the cover 51, facilitating operating, by a user, the control module 61 through the control panel.

As another embodiment of the driving unit 20, the driving unit 20 is implemented as a hydraulic cylinder capable of driving the sliding block body 33 to reciprocate along the extension direction of the guide rail 34. Specifically, a cylinder body of the hydraulic cylinder is installed on the guide rail 34, and a piston rod of the hydraulic cylinder extends along the extension direction of the guide rail 34 and is connected to the sliding block body 33 or the supporting part 42.

As another embodiment of the driving unit 20, the driving unit 20 is implemented as a linear motor capable of driving the sliding block body 33 to reciprocate along the extension direction of the guide rail 34. Specifically, a motor frame of the linear motor is installed on the guide rail 34, and a driving rod of the linear motor extends along the extension direction of the guide rail 34 and is connected to the sliding block body 33 or the supporting part 42.

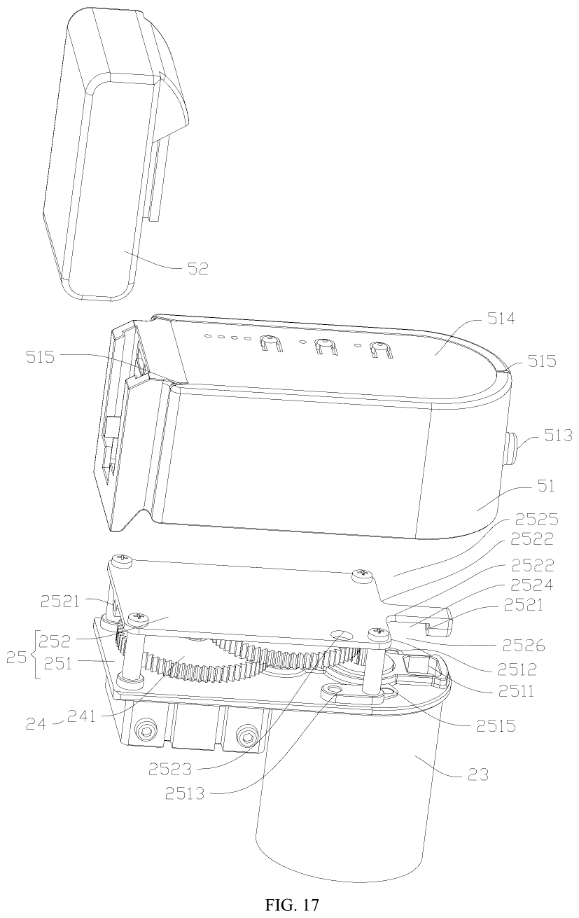

As a preferred embodiment, as shown in FIG. 16 and FIG. 17, the cover 51 is integrally formed or processed with a third accommodating cavity 511 and a third opening 512 which communicates the third accommodating cavity 511 with the outside, and the third opening 512 is formed in a third bottom 516 of the cover 51. The control module 61 is installed on the cover 51 and is located in the third accommodating cavity 511. A support 25 of the driving unit 20 is detachably connected to the cover 51. Specifically, the cover 51 is integrally formed, processed or connected with a first connecting structure 513, the first connecting structure 513 being disposed on a first side wall 517 of the cover 51. The support 25 is integrally formed, processed or connected with a second connecting structure 2521, and the cover 51 is detachably connected, via the first connecting structure 513 on the cover 51, to the second connecting structure 2521 on the support 25. Exemplarily, at least one of the first connecting structure 513 and the second connecting structure 2521 is a screw hole. When merely one of the first connecting structure 513 and the second connecting structure 2521 is a screw hole, the other can be a through hole. For example, the first connecting structure 513 is a through hole and the second connecting structure 2521 is a screw hole. The first connecting structure 513, connected to the support 25, of the cover 51 can be disposed on any other surface, except a second top face 514, of the cover 51. For example, the first connecting structure 513 is integrally formed, processed or connected with a side face or a bottom face of the cover 51. Preferably, as shown in FIG. 17, the first connecting structure 513 is disposed on the side face of the cover 51 to facilitate operation while preventing rainwater from entering the third accommodating cavity 511 through the first connecting structure 513. Exemplarily, the control module 61 can adopt a PLC or MCU of the prior art. The specific implementation of the control module 61 is not limited in the present disclosure. Further, the portable car lifting apparatus of the present application further includes a power supply 52 for supplying power to the driving device 23 and the control module 61. Preferably, the power supply 52 is detachably connected to the cover 51, for example, the power supply 52 is in inserted connection with the cover 51, and the power supply 52, the cover 51, the control module 61 and the driving device 23 are configured such that when the power supply is connected to the cover 51, connection lines between the power supply and the control module 61 and between the power supply and the driving device 23 are connected (for example, the cover 51 is connected with a socket, and the socket is electrically connected to the control module 61 in the cover 51, and the power supply 52 is electrically connected with a plug), and whether the power supply supplies power to the driving device 23 or not can be controlled by the control module 61. Preferably, the power supply 52 is a rechargeable battery. Preferably, as shown in FIG. 18, the cover 51 is located at a first upper position 232 of the driving device 23.

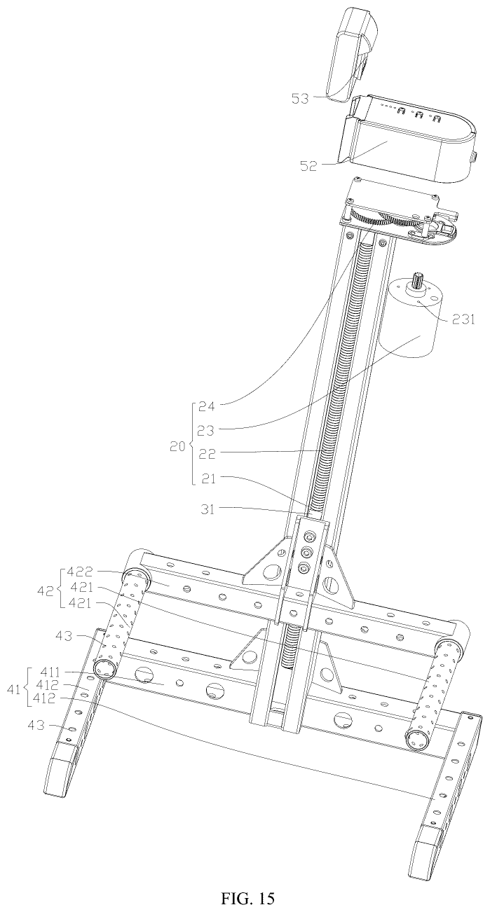

Preferably, as shown in FIG. 15 and FIG. 17, the power supply 52 can also be removed from the guide rail 34 for easy storage.

In some preferred embodiments, the driving device 23 of the driving unit 20 is detachably connected to the support 25, and/or the driving device 23 is electrically connected in a detachable manner to at least one of the control module 61 and the power supply 52. The control module 61 is used to control the start and stop of the driving device 23, and the driving device 23 is a rotary motor. Therefore, the portable car lifting apparatus with the driving unit 20 raises the position of the car, and then the power supply 52, the cover 51 connected with the control module 61, and the driving unit 20 can be removed (as shown in FIG. 15) to avoid damage to the power supply 52, the control module 61 and the driving unit 20 due to water ingress. Moreover, when the driving device 23 is also electrically connected in a detachable manner to at least one of the control module 61 and the power supply 52, the disassembly speed of the driving device 23, the control module 61 and the power supply 52 can also be increased. Preferably, as shown in FIG. 17, the cover 51 is located above the driving device 23, so that when the driving device 23 and the cover 51 are not removed from the support 25, the driving device 23 can also be shielded, by the cover 51, from rain.

As one of the embodiments of the support 25, as shown in FIG. 16 and FIG. 17, the support 25 includes a bottom plate 251 and a top plate 252 that are connected to each other. A transmission unit 24 of the driving unit 20 is provided between the bottom plate 251 and the top plate 252. The driving device 23 is detachably connected to the bottom plate 251 and is located at a second lower position 2514 of the bottom plate 251. The transmission unit 24 and the top plate 252 are located in the third accommodating cavity 511. A first passage 2511 through which a connecting line for connecting the driving device 23 to the control module 61 or the power supply 52 passes is integrally formed or processed in the bottom plate 251. Exemplarily, the first passage 2511 is a through hole integrally formed or processed in the bottom plate 251. Therefore, this can prevent, by the cover 51, the transmission unit 24 and the connecting line from external interference during operation. Particularly, as shown in FIG. 17, a second side 2524 and a third side 2525, located above the first passage 2511, of the top plate 252 are integrally formed or processed with avoidance structures 2522. Exemplarily, the avoidance structure 2522 is a through hole or barrel groove integrally formed or processed in the top plate 252, so as to provide a path for the connecting line while avoiding mutual interference between the connecting line and the transmission unit 24. Further, as shown in FIG. 17, the bottom plate 251 at a fourth lower position 2526 of the avoidance structure 2522 is provided with a third connecting structure 2512 for connecting the bottom plate 251 to the driving device 23. Exemplarily, the third connecting structure 2512 is a through hole or screw hole integrally formed or processed in the bottom plate 251, so as to provide a path for the connecting line while connecting the driving device 23 to the bottom plate 251. Even further, in addition to the third connecting structure 2512, the bottom plate 251 is also provided with a first positioning hole 2515 corresponding to a fourth connecting structure 231 which is on the driving device 23 and used for connecting to the bottom plate 251. Since it is generally needed to connect three evenly-distributed positions of the two components to form a relatively stable connecting relationship. However, due to structural limitations, the avoidance structures 2522 are merely provided on both sides of the position, corresponding to the first passage 2511, of the top plate 252. At most, merely two third connecting structures 2512 for connecting to the driving device 23 can be provided on the bottom plate 251. To prevent the driving device 23 connected to the bottom plate 251 from shaking during operation, a first positioning hole 2515 corresponding to at least one of the fourth connecting structures 231 of the driving device 23 is also formed in the bottom plate 251, thereby preventing the driving device 23 connected to the bottom plate 251 from shaking during operation.

As an embodiment of the transmission unit 24, as shown in FIG. 17, the transmission unit 24 is a gear pair 241 which is pivotally installed on the bottom plate 251 and the top plate 252 and located therebetween. In other words, each gear of the gear pair 241 is pivotally installed on the bottom plate 251 and the top plate 252, and rotating shafts of all the gears are arranged parallel to each other, and the gears of the gear pair 241 mesh with each other in pairs. Preferably, as shown in FIG. 17, a second passage 2523 through which a manual driving rod for manually driving the gear pair 241 to rotate passes is integrally formed or processed in the top plate 252, and a second positioning hole 2513 for positioning the manual driving rod is integrally formed or processed in the bottom plate 251. The manual driving rod is configured such that when the manual driving rod is inserted into the second positioning hole 2513, the gear on the manual driving rod can mesh with one gear of the gear pair 241. Therefore, even if the power of the power supply 52 is exhausted, or at least one of the control module 61 and the driving device 23 is damaged, an operator still can drive the gear pair 241 to operate through manually cranking the manual driving rod in special circumstances by disassembling the cover 51 from the support 25 and causing the manual driving rod to pass through the second passage 2523 and to be inserted into the second positioning hole 2513 for positioning.

As another embodiment of the transmission unit 24, the transmission unit 24 can adopt an existing pulley transmission structure.

As another embodiment of the transmission unit 24, the transmission unit 24 can adopt an existing sprocket transmission structure.

As one of the preferred embodiments of the cover 51, as shown in FIG. 17, the second top face 514 of the cover 51 is provided with a control panel for controlling the control module 61. The control panel can be a control panel used in the prior art, and the specific implementation of the control panel is not limited in the present disclosure. The second top face 514 of the cover 51 is covered with a waterproof film. A drainage groove 515 for communicating a side edge of the second top face 514 to the outside is integrally formed or processed in the second top face 514 of the cover 51. The waterproof film covering the second top face 514 can prevent water from seeping into the third accommodating cavity 511 from the second top face 514, and the drainage groove 515 formed in the side edge of the second top face 514 can prevent water from accumulating on the second top face 514, further preventing water from seeping into the third accommodating cavity 511 from the second top face 514 of the cover. In other embodiments, it can also be that either of the waterproof film and the drainage groove 515 is provided; that is, not provided simultaneously.

As one of the preferred embodiments of the sliding block body 33, the sliding block body 33 is pivotally connected, around a first pivot shaft 32, to the first nut 21. Specifically, as shown in FIG. 18 to FIG. 21, the sliding block body 33 is pivotally connected to the first connecting piece 31 which is fixedly disposed relative to the first nut 21. In some possible embodiments, the first connecting piece 31 can be connected to the first nut 21 or can be integrally formed with the first nut 21, and the supporting part 42 can be connected to the first nut 21 or can be connected to the first connecting piece 31. In other embodiments, the sliding block body 33 can also be directly and pivotally connected to the first nut 21. Therefore, even if the sliding block body 33 deviates from the fit clearance with the guide rail 34 due to wear during processing, installation and use, the sliding block body 33 can, through its pivotal movement around a second axis 321 of the first pivot shaft 32, move smoothly relative to the guide rail 34, thus the friction between the sliding block body 33 and the guide rail 34 can be reduced. In a preferred embodiment, the second axis 321 of the first pivot shaft 32 is perpendicular to the extension direction of the guide rail 34.

Preferably, the first nut 21 and the first pivot shaft 32 are both made of high-strength rigid materials, and the sliding block body 33 is made of a material with a hardness lower than that of the guide rail 34. The hardness of the sliding block body 33 is lower than that of the guide rail 34, which enables the sliding block body 33 to have a certain tension. Meanwhile, since the sliding block body 33 is pivotally connected to the first nut 21, even if a sliding block module (referring to a structure composed of the sliding block body, the first nut, the first pivot shaft, and the guide rail) bears a load, the sliding block body 33, when moving relative to the guide rail 34, will not be embedded in the guide rail even if rotating relative to the first nut 21, thereby ensuring that the sliding block body 33 can move smoothly relative to the guide rail 34. Further, the sliding block body 33 is made of plastic or a lightweight metal material, and/or at least one of the first nut 21 and the first pivot shaft 32 is of a hollow structure, thereby further achieving the purpose of weight reduction. The first nut 21 and the first pivot shaft 32 being prepared using high-strength rigid materials is to improve the strength of the first nut 21 and the first pivot shaft 32 and avoid deformation of the first nut 21 and the first pivot shaft 32, ensuring the stability of the sliding block module (referring to the structure composed of the sliding block body, the first nut, the first pivot shaft, and the guide rail). For example, titanium alloy, magnesium alloy or aluminum alloy are used. Generally, the guide rail 34 is made of alloy steel, and correspondingly, the sliding block body 33 can be made of plastic or lightweight metal materials such as aluminum alloy, or other non-metallic materials such as carbon fiber. The plastic includes, for example, general-purpose plastics such as PE, PP, PVC, PS, ABS, or engineering plastics such as PA, PC, POM, PPO, PET, or special plastics such as PSU, PPS, PEEK, PTFE, polyimide. Preferably, the sliding block body 33 is made of high-density plastic to have both high-strength and lightweight characteristics.

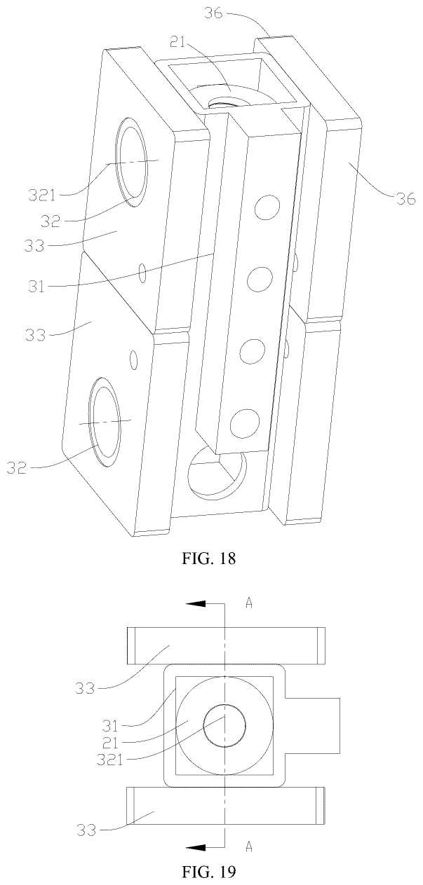

Further preferably, the sliding block body 33 is at least disposed at one side of the first nut 21, and at least two sliding bodies 33 are provided at the same side of the first nut 21, and the sliding block bodies 33 at the same side are arranged in sequence along the extension direction of the guide rail 34. Therefore, the length of the sliding block body 33 adapted to the guide rail 34 can be extended to ensure that the first nut 21 can stably move along the guide rail 34 under the driving of the driving unit 20. Moreover, at least two sliding block bodies 33 are disposed along the extension direction of the guide rail 34, such that different sliding block bodies 33 rotate more freely relative to the first nut 21, thereby avoiding the problem that the sliding block body 33 is prone to being embedded in the guide rail 34 due to the increased length of the sliding block body 33 adapted to the guide rail 34. Preferably, the sliding block bodies 33 are provided at two sides facing away from each other of the first nut 21, so that when the sliding block bodies 33 are adapted to the guide rail 34, the first nut 21 can move more steadily relative to the guide rail 34. As shown in FIG. 18, FIG. 19 and FIG. 21, the structural relationship between the sliding block bodies and the first nut is illustrated by an example in which the two sliding block bodies 33 are disposed at two sides facing away from each other of the first nut 21. In this embodiment, the sliding block body 33 has two side faces 36 that are away from each other and can fit with the guide rail 34 to achieve face contact between the sliding block body 33 and the guide rail 34. For example, the sliding block body 33 is integrally formed or processed into a square plate-like structure. Therefore, even if the sliding block body 33 rotates relative to the first nut 21, the sliding block body 33 can, by means of the side face 36 of the sliding block body 33, fit with the guide rail 34, preventing the sliding block body 33 from deforming the contact face under a larger pressure due to the smaller contact face with the guide rail 34. Moreover, in a case of face contact between the sliding block body 33 and the guide rail 34, it can be ensured that the sliding block body 33 is adapted, in a relatively stable manner, on the guide rail 34 due to the larger area of the sliding block body 33 adapted to the guide rail 34. Preferably, the contact between adjacent sliding block bodies 33 at the same side of the first nut 21 is face contact, thereby preventing the rotation of the sliding block body 33 relative to the first nut 21 from being hindered by the adjacent sliding block bodies 33.

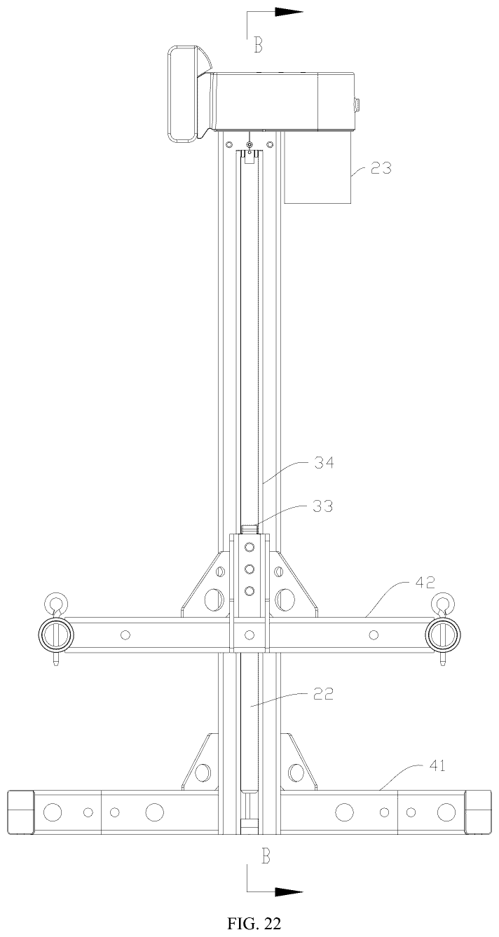

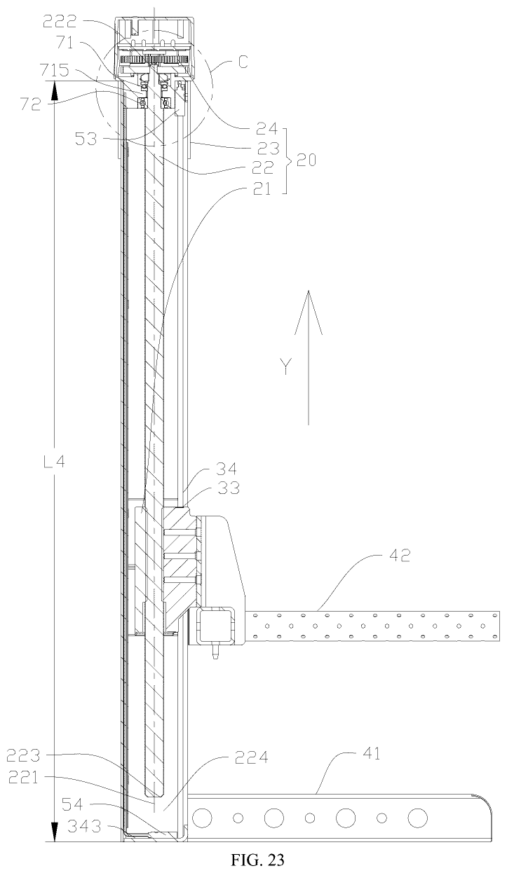

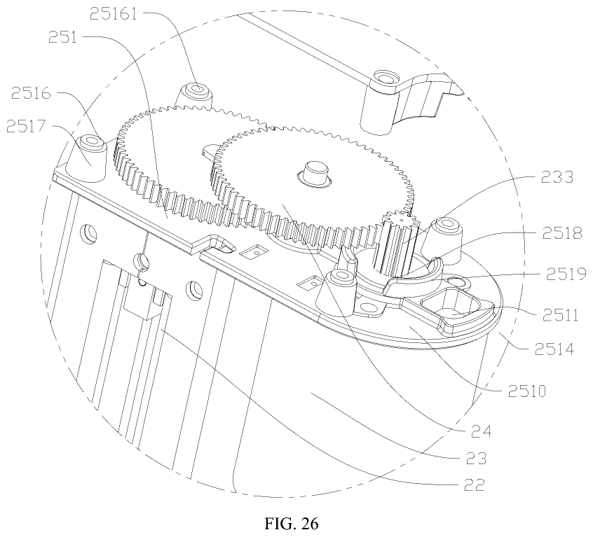

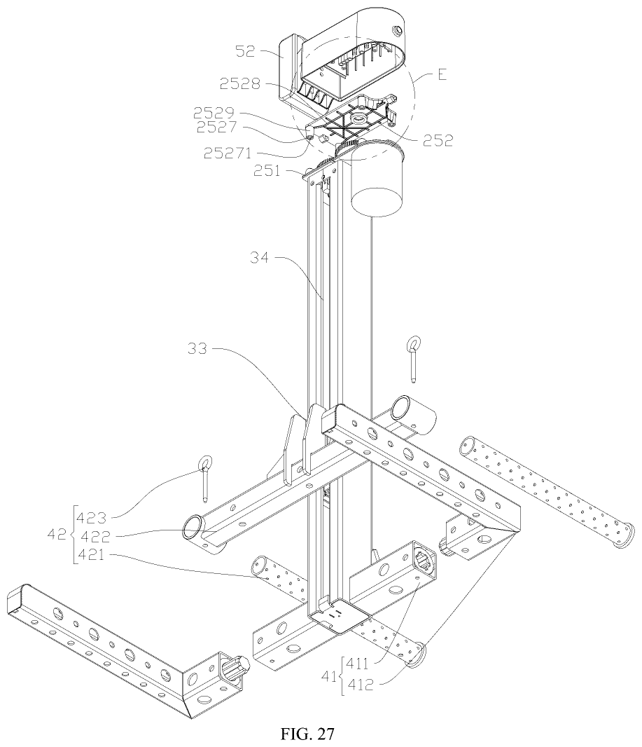

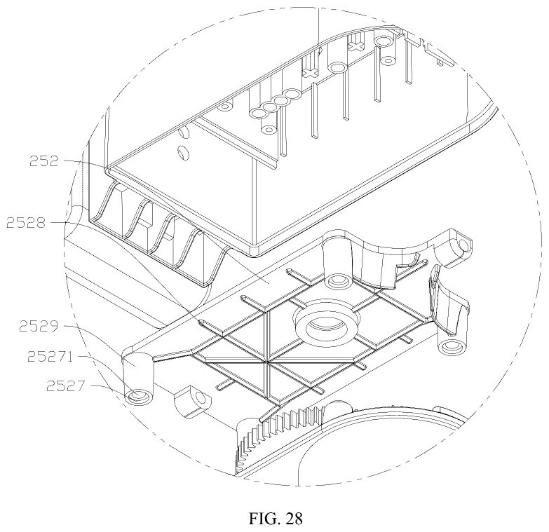

FIG. 22 to FIG. 29 schematically illustrate a portable car lifting apparatus according to a second embodiment of the present application. The main difference between the portable car lifting apparatus of this embodiment and the portable car lifting apparatus of the first embodiment lies in the connection mode between the driving unit 20 and the guide rail 34, and how a detection module is disposed based on this. The details are as follows.

In some preferred embodiments, as shown in FIG. 23 and FIG, 24, the driving unit 20 is configured such that when the driving unit 20 drives the supporting part 42 to move along the vertical direction Y, the second top 222 of the driving unit 20 is disposed on the guide rail 34 via a load bearing 71. Specifically, when the driving unit 20 includes a first screw rod 22 and a first nut 21 that are adapted to each other. The load bearing 71 is configured such that when the first screw rod 22 is disposed along the vertical direction Y, the load bearing 71 is sleeved on the second top 222 of the first screw rod 22, and the second top 222 of the first screw rod 22 is disposed on the guide rail 34 via the load bearing 71, so that the first screw rod 222 can rotate, around a central axis thereof (the first axis 221), relative to the guide rail 34, and the gravity borne by the first screw rod 22 (the gravity borne by the first screw rod 22 includes the gravity of the first screw rod 22 itself, the gravity directly acting on the first screw rod 22, and the gravity acting on the first screw rod 22 through the first nut 21, etc.) can act on the guide rail 34 via the load bearing 71. Therefore, when the first screw rod 22 rotates around its own central axis and drives the first nut 21 and an object on the first nut 21 to reciprocate along the extension direction of the central axis of the first screw rod 22, since the second top 222 of the driving unit 20 which is driven along the vertical direction Y is provided with the load bearing 71 capable of bearing gravity along the vertical direction Y, bending of the first screw rod 22 can be avoided to a larger extent. Preferably, as shown in FIG. 22 and FIG. 23, the first bottom 223 of the first screw rod 22 of the driving unit 20 is disposed as being suspended relative to the guide rail 34. Therefore, when the first nut 21 drives the object to move along the extension direction Y of the first screw rod 22, the first screw rod 22 can be prevented from bending. Preferably, with continued reference to FIG. 23, the portable car lifting apparatus further includes a second detection module 54. The second detection module 54 is disposed close to a second bottom 343 of the guide rail 34 and is located at a third lower position 224 of the first bottom 223 of the first screw rod 22. Therefore, not only the lower limit position of the first nut 21 can be detected by the second detection module 54, but also the first nut 21, the sliding block body 33 or the supporting part 42 can be prevented from colliding with the second detection module 54, thereby ensuring the detection accuracy of the second detection module 54.

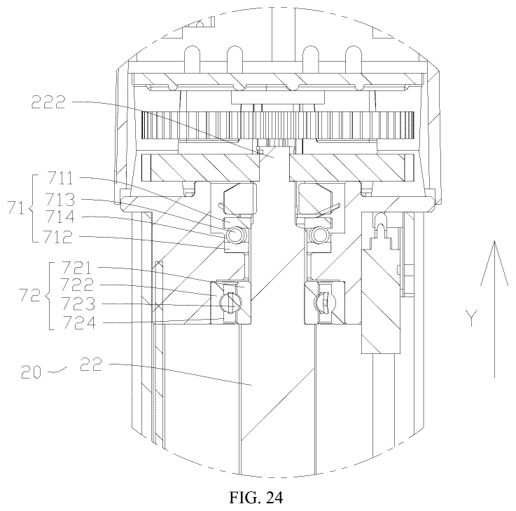

As some specific embodiments of the load bearing 71, thrust ball bearings, cylindrical roller bearings, etc., can be used. When the first screw 22 is disposed along the vertical direction Y, these bearings can bear the gravity borne by the first screw 22 in the vertical direction. Taking the thrust ball bearing as an example, as shown in FIG. 23 and FIG. 24, the thrust ball bearing includes a shaft ring 711, a seat ring 712, a first steel ball 713 and a first retaining frame 714. The first screw 22 is disposed on the shaft ring 711. The first steel ball 713 is prevented from colliding with each other by the first retaining frame 714 and is located between the shaft ring 711 and the seat ring 712. The seat ring 712 is disposed on the guide rail 34. When the first screw 22 is disposed along the vertical direction Y, the bottom of the seat ring 712 abuts against the guide rail 34, and at the same time, the shaft ring 711 is located above the seat ring 712. In other words, the thrust ball bearing is an upper-lower structure arranged along the extension direction Y of the first screw 22, the first screw 22 being connected to the guide rail 34 through the thrust ball bearing. In other words, the thrust ball bearing is configured such that when the driving unit 20 drives along the vertical direction Y, the thrust ball bearing is disposed at the top of the driving unit 20 and can bear the gravity along the driving direction Y of the driving unit 20.

In some preferred embodiments, as shown in FIG. 23, the portable car lifting apparatus further includes a first detection module 53. The first detection module 53 is disposed at a position, close to the second top 222 of the first screw rod 22, of the guide rail 34, and the first detection module 53 is disposed at one side where the supporting part 42 is located. Therefore, not only the upper limit position of the first nut 21 can be detected by the first detection module 53, but also the first nut 21, the sliding block body 33 or the supporting part 42 can be prevented from colliding with the first detection module 53, thereby ensuring the detection accuracy of the first detection module 53.

As one of the embodiments of the first detection module 53 and the second detection module 54, an infrared sensor or a proximity switch can be adopted.

In some preferred embodiments, as shown in FIG. 23 and FIG. 24, the portable car lifting apparatus further includes a rotary bearing 72. The rotary bearing 72 is disposed at the second top 222 of the first screw rod 22. The first screw rod 22 is connected to the guide rail 34 via at least one of the load bearing 71 and the rotary bearing 72. Since the rotary bearing 72 is also disposed at the second top 222 of the first screw rod 22, the first screw rod 22 can be ensured to rotate smoothly. Preferably, the rotary bearing 72 is disposed at a first lower position 715 of the load bearing 71. Therefore, it can be that not only the gravity born by the first nut 21 adapted to the first screw rod 22 is borne by the load bearing 71, but also the first screw rod 22 can be ensured to smoothly rotate by the rotary bearing 72. Moreover, since the gravity acting on the first screw rod 22 (including the gravity acting directly and indirectly on the first screw rod 22) is applied to the guide rail 34 of a chassis through the load bearing 71, and will not act on the rotating bearing 72, it can be ensured that under the action of the rotary bearing 72, the first screw rod 22 can rotate relative to the guide rail 34 around its own central axis.

As some embodiments of the rotary bearing 71, as shown in FIG. 23 and FIG. 24, ball bearings, roller bearings, etc., can be used. The first screw 22 is disposed on the guide rail 34 via these bearings, which can ensure that the first screw 22 rotates relative to the guide rail 34 around its own central axis. Taking the ball bearing as an example, the ball bearing includes an inner ring 721, an outer ring 722, a second steel ball 723 and a second retaining frame 724. The inner ring 721 is disposed on the first screw 22. The second steel ball 723 is prevented from colliding with each other by the second retaining frame 724 and is located between the inner ring 721 and the outer ring 722. The outer ring 722 is disposed on the guide rail 34. The inner ring 721 is sleeved on the outer side of the first screw rod 22, and the outer ring 722 is sleeved on the outer side of the inner ring 721. The first screw rod 22, the inner ring 721 and the outer ring 722 form a central circular structure. In other words, the ball bearing is an inner-outer structure arranged along the radial direction of the first screw rod 22, thereby ensuring that the first screw rod 22 rotates smoothly. The ball bearing is configured to, when the driving unit 20 drives along the vertical direction Y, bear neither the gravity of the driving unit 20 nor the gravity of the guide rail 34.

The main difference between the portable car lifting apparatus of this embodiment and the portable car lifting apparatus of the first embodiment lies in how the support 34 is disposed. The details are as follows.

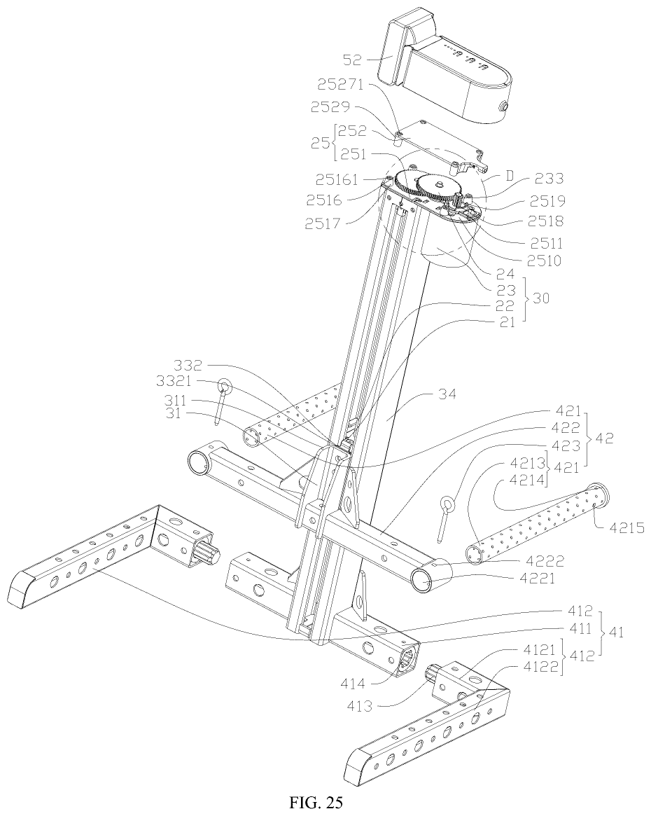

To ensure the smooth operation of the transmission unit 33 while ensuring the lightweight of the driving unit 20, as shown in FIG. 25 to FIG. 28, the portable car lifting apparatus further includes a support 25. The support 25 includes a bottom plate 251 and a top plate 252 that are connected to each other. The transmission unit 24 is disposed between the bottom plate 251 and the top plate 252. The driving device 23 is detachably connected to the bottom plate 251 and is located at a second lower position 2514 of the bottom plate 251. A first passage 2511 through which a connecting line for connecting the driving device 23 to the control module or the power supply 52 passes is integrally formed or processed in the bottom plate 251. Exemplarily, the first passage 2511 is a through hole integrally formed or processed in the bottom plate 251. Therefore, this can prevent, by the support 25, the transmission unit 24 and the connecting line from external interference during operation. As one of the connection modes between the bottom plate 251 and the top plate 252, the bottom plate 251 is detachably connected to the top plate 252. For example, the bottom plate 251 is detachably connected to the top plate 252 via a screw. Exemplarily, a first screw hole 25161 is processed in the bottom plate 251, and a fifth through hole 25271 adapted to the first screw hole 25161 and capable of allowing the screw to pass through is integrally formed or processed in the top plate 252. Preferably, the periphery of the first screw hole 25161 of the bottom plate 251 is integrally formed, processed or connected with a first protrusion 2516, and the periphery of the fifth through hole 25271 of the top plate 252 is integrally formed or processed with a first recess 2527 corresponding to and adapted to the first protrusion 2516, so as to assist in alignment of the positions of the first screw hole 25161 and the fifth through hole 25271. Preferably, the bottom plate 251 is integrally formed, processed or connected with a first protruding column 2517, and/or the top plate 252 is integrally formed or processed with a second protruding column 2529, so that after the bottom plate 251 is connected to the top plate 252, the top plate 252 is raised above the bottom plate 251 by the first protruding column 2517 and/or the second protruding column 2529, forming a storage space for accommodating the transmission unit 24. Meanwhile, at least one of the bottom plate 251 and the top plate 252 is of a plate-like structure to achieve lightweight of the support. Further preferably, at least one of the first screw hole 25161 and the first protrusion 2516 is disposed on the first protruding column 2517, and/or at least one of the fifth through hole 25271 and the first recess 2527 is disposed on the second protruding column 2529, so as to improve the connection strength of the screw connection. Preferably, second protrusions 2528 are provided on a surface, facing the other, of at least one of the top plate 252 and the bottom plate 251 to improve the strength of the top plate 252 and the bottom plate 251. Further preferably, the second protrusions 2528 are ridges arranged in a criss-cross manner, forming reinforcing ribs disposed on the top plate 252 or the bottom plate 251. In some preferred embodiments, when the driving device 23 is installed at the second lower position 2514 of the bottom plate 251, and a driving shaft 233 of the driving device 23 passes through the bottom plate 251 via the third through hole 2518, a third protrusion 2519 is also integrally formed or processed on the first top face 2510 of the bottom plate 251, and the third protrusion 2519 is disposed at the periphery of the third through hole 2518 to prevent water from flowing into the driving device 23 from the periphery of the third protrusion 2519 via the third through hole 2518.

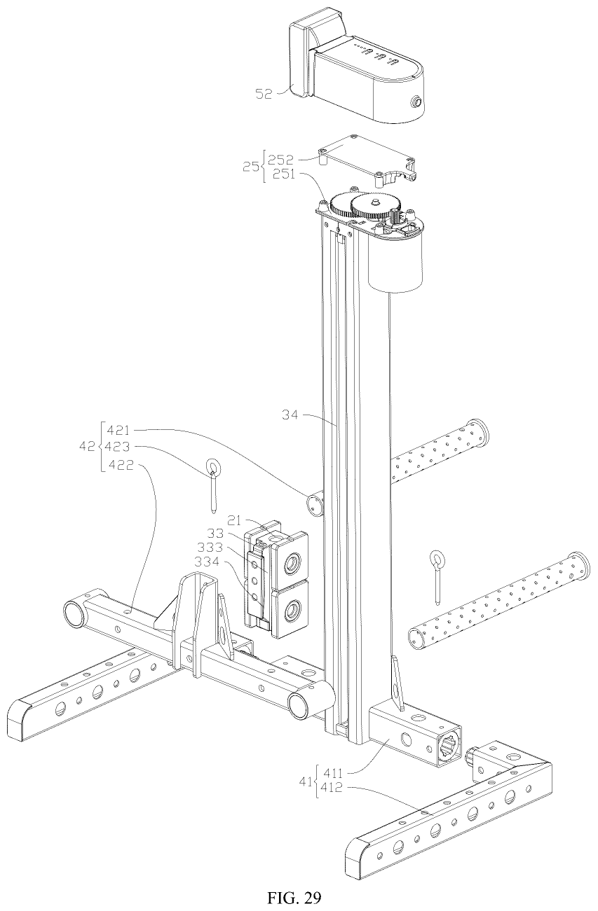

In some preferred embodiments, as shown in FIG. 29, the guide rail 34 is channel steel, and the structure in which the sliding block body 33 and the guide rail 34 are adapted is an H-shaped first groove 333, so as to prevent the sliding body 33, when moving along the extension direction Y of the guide rail 34, from falling off the guide rail 34. Preferably, a chamfer 334 is provided at one end, along the extension direction Y of the guide rail 34, of the sliding body 33 of the H-shaped structure, thereby providing a guidance for the adaption of the sliding block body 33 and the guide rail 34.

In some preferred embodiments, as shown in FIG. 29, the sliding block body 33 is integrally formed on the first nut 21. Therefore, the stability of the sliding block body 33 can be ensured.

FIG. 30 schematically illustrates a car lifting system according to an embodiment of the present application.

As shown in FIG. 30, the car lifting system includes a master control module 62 and four sets of the above portable car lifting apparatus. The master control module 62 is configured to be capable of controlling the start and stop of the control module 61. Therefore, controlled by the master control module 62, the four sets of portable car lifting apparatus can start together or one of the four sets of portable car lifting apparatus can start.

In the present application, “high-strength” refers to a yield strength greater than 210 MPa.

In the present application, “lightweight metal” is consistent with the general definition in the field of materials, including metallic titanium, metallic aluminum, metallic magnesium, metallic lithium, etc.

In the present application, connection or installation refers to a fixed connection unless otherwise emphasized. The fixed connection can be implemented as a detachable connection or a non-detachable connection commonly used in the prior art. The detachable connection can be implemented using the prior art, such as threaded connection or key connection. The non-detachable connection can also be implemented using the prior art, such as welding or gluing.

The above are merely some embodiments of the present application. For those of ordinary skills in the art, several modifications and improvements can be made without departing from the creative concept of the present application, and these all fall within the protection scope of the present application.

What is claimed is:

1. A portable car lifting mechanism, comprising:
a base;
a moving unit fixedly provided relative to the base; and
a supporting part capable of moving relative to the base along a vertical direction Y under driving of the moving unit, the supporting part being configured to be capable of supporting wheels of a car;
wherein the base and the supporting part are both disposed at a first side of the moving unit, and the base is located at an outer side of the supporting part.

2. The portable car lifting mechanism according to claim 1, wherein at least one of the base and the supporting part is configured as a U-shaped structure;
openings of the U-shaped structures are all provided as facing towards one side away from the moving unit;
at least one of the base and the supporting part is made of a hollow tube, and/or first through holes are formed in at least one of the base and the supporting part; and
a height of the base is greater than that of the supporting part.

3. The portable car lifting mechanism according to claim 2, wherein the supporting part and the moving unit are detachably connected; and/or
the supporting part comprises a connecting part connected to the moving unit, and two contact parts detachably connected via the connecting part and used for being in contact with the wheels, the connecting part and the contact parts jointly forming the U-shaped structure; and/or
the base comprises a connecting tube fixed relative to the moving unit, and two side tubes detachably connected via the connecting tube, the connecting tube and the side tubes jointly forming the U-shaped structure;
a distance d1 from the side tubes to the connecting tube is greater than a distance d2 from the contact parts to the connecting part;
the connecting tube is non-rotatably connected to the side tubes;
the contact parts are in threaded connection with the connecting part; and/or the connecting tube is in inserted connection with the side tubes via spline slots and spline shafts;
a first top of the contact part is configured as an arc shape, and the contact part is of a cylindrical tubular structure; and/or the connecting tube and the side tubes are square tubes with square cross sections, and widths of the side tubes are smaller than heights of the side tubes; and
at least one of the connecting tube, the side tubes, the contact parts and the connecting part is a seamless steel tube.

4. The portable car lifting mechanism according to claim 3, wherein the moving unit comprises a guide rail and sliding block bodies that are adapted to each other,
the guide rail is disposed along the vertical direction Y;
the base is relatively fixed on the guide rails;
the supporting part is disposed on the sliding block bodies;
the guide rail is hollow channel steel;
the sliding block bodies are located at a hollow part of the channel steel; and
a rust-proof coating is provided on a surface of at least one of the base, the supporting part and the guide rail.

5. The portable car lifting mechanism according to claim 4, wherein the side tubes are L-shaped, the two side tubes being detachably connected to a first free end and a second free end of the connecting tube respectively to form the U-shaped structure.

6. The portable car lifting mechanism according to claim 5, wherein each side tube comprises a short side and a long side that are connected in sequence to form an L-shaped structure;
the connecting tube is linear, and an intermediate part thereof is used for connecting with the guide rail;
the spline shafts are disposed on a third free end of the short side, and the spline slots are formed in the first free end and the second free end of the connecting tube, and a sum of lengths of the short side and the spline shafts is L1, and a length from the first free end or the second free end of the connecting tube to the guide rail is L2, and the absolute value of a difference between L1 and L2 is smaller than 10 mm; and/or
a length L3 of the long side of the side tube of the base is smaller than a length L4 of the guide rail.

7. The portable car lifting mechanism according to claim 6, further comprising a first connecting piece, the supporting part being connected to the sliding block body via the first connecting piece, and the length of the first connecting piece is L7, and the absolute value of a difference between L7 and L2 is smaller than 10 mm; and/or
the supporting part comprises the connecting part, and the contact parts detachably connected to a fourth free end and a fifth free end of the connecting part, and the absolute value of a difference between twice a length L6 of the contact part and the length L4 of the guide rail is smaller than 10 mm, and a length L5 of the connecting part is smaller than the length L4 of the guide rail.

8. A portable car lifting apparatus, comprising the portable car lifting mechanism according to claim 1; and
further comprising a driving unit having a locking function, the driving unit being capable of driving the moving unit to drive the supporting part to move along the vertical direction Y.

9. The portable car lifting apparatus according to claim 8, wherein the driving unit comprises:
a first screw rod rotatably provided, around a first axis thereof, relative to the moving unit, the first screw rod being disposed along the direction Y in which the moving unit drives the supporting part to move;
and a first nut adapted onto the first screw rod, the first nut being disposed on the moving unit;
the first screw rod is rotatably disposed relative to a guide rail of the moving unit and the first screw rod is disposed along an extension direction Y of the guide rail, the first nut being disposed on a sliding block body, adapted to the guide rail, of the moving unit;
the guide rail is hollow channel steel, and the first screw rod and the first nut are located at a hollow part of the channel steel.

10. The portable car lifting apparatus according to claim 9, wherein when the driving unit drives the supporting part to move along the vertical direction Y, a second top of the driving unit is provided on the guide rail via a load bearing which can bear gravity along a driving direction Y of the driving unit.

11. The portable car lifting apparatus according to claim 10, wherein the first screw rod is disposed along the vertical direction Y;
the load bearing is disposed at a second top of the first screw rod;
the portable car lifting apparatus further comprising a rotary bearing, the rotary bearing being disposed at the second top of the first screw rod; and
the first screw rod is connected to the guide rail via at least one of the load bearing and the rotary bearing.

12. The portable car lifting apparatus according to claim 11, wherein the rotary bearing is disposed at a first lower position of the load bearing;
the load bearing is an upper-lower structure arranged along the extension direction Y of the first screw rod; and/or
the rotary bearing is an inner-outer structure arranged along a radial direction Y of the first screw rod;
the sliding block body is integrally formed on the first nut;
a first bottom of the first screw rod of the driving unit is disposed as being suspended relative to the guide rail of the driving unit.

13. The portable car lifting apparatus according to the claim 12, further comprising at least one of a first detection module and a second detection module;
the first detection module is disposed at a position, close to the second top of the first screw rod, of the guide rail, and the first detection module is disposed at one side where the supporting part is located;
the second detection module is disposed at a position close to a second bottom of the guide rail, and is located at a third lower position of a first bottom of the first screw rod; and/or
the supporting part is connected to the sliding block body via a first connecting piece, and one end, same as the second top of the first screw rod, of one side, connected to the first connecting piece, of the sliding block body is configured to have a first step, and a first upper surface of the first step is flush with a second upper surface of the first connecting piece.

14. The portable car lifting apparatus according to claim 9, wherein the driving unit further comprises a driving device for driving the first screw rod to move;
the driving unit also comprises a control module for driving a start and a stop of the driving device; and
at least one of the driving device and the control module can be detachably disposed relative to the guide rail.

15. The portable car lifting apparatus according to claim 14, further comprising a cover, the cover being provided with a third accommodating cavity and a third opening which communicates the third accommodating cavity with outside, the third opening being formed in a third bottom of the cover; and
a support of the driving unit, detachably connected to the cover; wherein
the control module is disposed on the cover and located in the third accommodating cavity;
a first connecting structure, connected to the support, of the cover is provided on a first side wall of the cover;
the portable car lifting apparatus also comprises a power supply, the power supply being in inserted connection with the cover, and the power supply is electrically connected to the control module when the power supply is in proper inserted connection with the cover;
the driving device is detachably connected to the support, and/or the driving device is electrically connected in a detachable manner to at least one of the control module and the power supply, and the cover is located at a first upper position of the driving device.

16. The portable car lifting apparatus according to claim 15, wherein the support comprises a bottom plate and a top plate that are connected to each other;
a transmission unit of the driving unit is provided between the bottom plate and the top plate;
the driving device is detachably connected to the bottom plate, and is located at a second lower position of the bottom plate;
the transmission unit and the top plate are located in the third accommodating cavity;
the bottom plate is provided with a first passage through which a connecting line for connecting the driving device to the control module or the power supply passes;
a second side and a third side, located above the first passage, of the top plate are provided with avoidance structures;
the bottom plate at a fourth lower position of the avoidance structure is provided with a third connecting structure for connecting the bottom plate to the driving device;
in addition to the third connecting structure, the bottom plate is further provided with a first positioning hole corresponding to a fourth connecting structure which is on the driving device and used for connecting to the bottom plate;
the transmission unit is a gear pair which is installed between the bottom plate and the top plate, and the top plate is provided with a second passage through which a manual driving rod for manually driving the gear pair to rotate passes, and the bottom plate is provided with a second positioning hole for positioning the manual driving rod.

17. The portable car lifting apparatus according to claim 16, wherein one of the bottom plate and the top plate is provided with a first protrusion, and the other is provided with a first recess adapted to the first protrusion; and/or
at least one of the bottom plate and the top plate is provided with a second protrusion;
the bottom plate is provided with a third through hole for a driving shaft of the driving device to pass through; a second top face of the bottom plate is provided with a third protrusion, the third protrusion being disposed at a periphery of the third through hole.

18. The portable car lifting apparatus according to claim 9, wherein the sliding block body is pivotally connected to the first nut around a first pivot shaft, and a second axis of the first pivot shaft is perpendicular to the extension direction Y of the guide rail;
the first nut and the first pivot shaft are both made of high-strength rigid materials, and the sliding block body is made of a material with a hardness lower than that of the guide rail;
the sliding block body is made of plastic or a lightweight metal material, and/or at least one of the first nut and the first pivot shaft is of a hollow structure.

19. The portable car lifting apparatus according to claim 18, wherein the sliding block body has two side faces that are away from each other and can fit with the guide rail to achieve face contact between the sliding block body and the guide rail;
the sliding block body is at least disposed at one side of the first nut, and at least two sliding block bodies are provided at the same side of the first nut, and the sliding block bodies at the same side are arranged in sequence along the extension direction Y of the guide rail; and the sliding block bodies are provided at two sides facing away from each other of the first nut.

20. A car lifting system, comprising a master control module and four sets of the portable car lifting apparatus according to claim 14, wherein:
the master control module is configured to be capable of controlling the start and the stop of the control module.
